(19) United States
(12) Patent Application Publication
(10) Pub. No.: US 2012/0173155 A1
(43) Pub. Date: Jul. 5, 2012

(54) NETWORK THREADING APPROACH FOR PREDICTING A PATIENT'S RESPONSE TO HEPATITIS C VIRUS THERAPY

(75) Inventors: Rajeev Aurora, Wildwood, MO (US); John Tavis, Kirkwood, MO (US)

(73) Assignee: ST. LOUIS UNIVERSITY, St. Louis, MO (US)

(21) Appl. No.: 13/341,410

(22) Filed: Dec. 30, 2011

Related U.S. Application Data
(60) Provisional application No. 61/428,543, filed on Dec. 30, 2010.

(51) Int. Cl. G06F 19/24

(52) U.S. Cl. 702/19

(57) ABSTRACT

The present invention generally relates to a computer-implemented method for predicting a response of a virus to antiviral therapy, and finds particular use in predicting a response of a Hepatitis C or Hepatitis B virus isolated from a patient.

### CROSS-REFERENCE TO RELATED APPLICATION

This application is a U.S. Non-Provisional Patent Application of U.S. Provisional Patent Application Ser. No. 61/428,543, filed Dec. 30, 2010, the entirety of which is herein incorporated by reference.

### STATEMENT OF GOVERNMENT SUPPORT

This work was funded in part by grant DK60345 from the National Institutes of health. The Government may have certain rights in the invention.

### FIELD OF THE INVENTION

The present invention generally relates to a computer-implemented method for predicting a response of a virus to antiviral therapy.

### BACKGROUND OF THE INVENTION

About 3.8 million Americans are chronically infected with Hepatitis C virus (HCV), and the Centers for Disease Control and Prevention estimate that hepatitis C causes 8,000-10,000 deaths each year in the USA. Currently, the best therapy for HCV infection is a combination of pegylated interferon alpha and ribavirin, a guanosine analogue. Treatment with these drugs for 24 to 48 weeks leads to sustained clearance of the virus and stabilization of liver function in 50-60% of genotype 1 patients (Manns, M. P., et al., Lancet 358, 958-965, 2001; Hadziyannis, S. J., et al., Ann. Intern. Med. 140, 346-355, 2004). Interferon (IFN) alpha provides the primary antiviral effect during therapy and can clear HCV even when used alone (Poynard, T., et al., Lancet 352, 1426-1432, 1998; McHutchison, J. G., et al., New England J. Med. 339, 1485-1492, 1998). Ribavirin cannot eliminate viremia by itself (Bodenheimer, N. C., et al., Hepatology 26, 473-477, 1997; Dusheiko, G., et al., J. Hepatol. 25, 591-598, 1996; Di Bisceglie, A. M., et al., Ann. Intern. Med. 123, 897-903 1995), although it can reduce viral titers slightly in some patients (Pawlotsky, J. M., et al., Gastroenterology 126, 703-714, 2004). When ribavirin is taken in combination with IFN alpha, it roughly doubles the viral clearance rate (McHutchison, J. G., et al., New England Journal of Medicine 339, 1485-1492, 1998; Poynard, T., et al., Lancet 352, 1426-1432, 1998; Davis, G. L., et al., New England J. Med. 339, 1493-1499, 1998), apparently by reducing relapse following the end of drug treatment. Unfortunately, there are no effective therapies for patients who fail to clear virus following IFN alpha plus ribavirin therapy.

The HCV genome is approximately 9,600 nucleotide long RNA that encodes a single polyprotein of about 3010 amino acids. The polyprotein is post-translationally cleaved by host and viral proteases to produce ten mature viral proteins. The core, E1, and E2 proteins form the virion, and P7-NS5B are nonstructural proteins with regulatory and/or enzymatic functions. The HCV genome is highly variable, and six HCV genotypes that are less than 72% identical at the nucleotide level have been identified (Simmonds, P. et al., J. General Virol. 74, 2391-2399, 1993; Bukh, J., et al., Seminars in Liver Disease 15, 41-63, 1995; Robertson, B., et al., Archives Virol. 143, 2493-2503, 1998; Simmonds, P., et al., Hepatology 42, 962-973, 2005; Bukh et al., 2005; Simmonds, P., J. Gen. Virol. 85, 3173-3188, 2004). Within these genotypes, subtypes with identities of 75-86% may occur. HCV replicates as a quasispecies rather than as a clonal population, and hence multiple closely-related HCV variants exist within individual patients. The quasispecies develops because the viral production rate is very high [about 10¹² virions per day; (Neumann, A. U., et al., Science 282, 103-107 1998)] and the viral RNA polymerase has low fidelity. Therefore, new mutations are constantly introduced into the viral pool, and each of these variant genomes is in competition with the others (Kurosaki, M. et al., Virology 205, 161-169, 1994; Zeuzem, S., Forum (Genova) 10, 32-42, 2000). The result is that at any given time, one or a few genomes will be dominant because they are the fittest for the prevailing conditions, as defined by host physiology, immune status, and antiviral drug challenge. The quasispecies distribution can vary with time through adaptive or neutral evolution (Simmonds, P., J. Gen. Virol. 85, 3173-3188, 2004). Adaptive changes are due to emergence of more fit variants as conditions facing the virus change. Neutral changes result from replacement of sequences with others of equivalent fitness. The high genetic variability of HCV has two fundamental biological effects. First, it provides diversity for rapid viral evolution in response to selective pressures, such as an immune response or antiviral pressure. Second, the diversity causes many viral genomes to contain variations that are either lethal or reduce fitness, leading to their loss from the viral population.

HBV is a small enveloped virus with a partially double-stranded DNA genome that is replicated by reverse transcription. Four sets of viral mRNAs encode 7 proteins: 3 surface glycoproteins (HBsAgs), a capsid protein (HBcAg), a secreted regulatory protein (HBeAg), a reverse transcriptase, and an intracellular regulatory protein (HBx). The surface glycoproteins contain the conserved immunodominant “a” epitope that is the target of protective antibodies elicited by the vaccine. Upon infection, HBV's genome is converted to the covalently-closed circular DNA (“cccDNA”) in the nucleus, which is the template for transcription of the viral mRNAs. The RNA form of the genome is encapsidated along with the reverse transcriptase, and reverse transcription occurs in the cytoplasm. Nascent viral capsids either enter the nucleus to maintain the cccDNA pool or bud through cellular membranes and are secreted from cells non-cytolytically as virions. Two forms of antiviral therapy exist. Interferon a triggers cellular effectors that suppress viral replication, and the nucleoside/nucleotide analogs block reverse transcription. HBV therapy is partially plagued by limited efficacy and either side effects for interferon a or resistance to the nucleos(t)ide analogs. HBV has 8 genotypes (A-H) that differ by ≧8% at the nucleotide level, and the genotypes have moderate differences in their response to therapy (Palumbo E. Hepatitis B genotypes and response to antiviral therapy: a review. Am J Ther 2007 May; 14(3):306-309).

The Viral Resistance to Antiviral Therapy of Chronic Hepatitis C clinical study (Virahep-C) investigated the efficacy of pegylated IFN alpha plus ribavirin for treating hepatitis C (Conjeevaram, H. S., et al., Gastroenterology 131, 470-477, 2006). As part of Virahep-C, the inventors performed a viral genetics study to identify viral genetic patterns associated with response or failure of therapy and to determine which viral genes are targets of antiviral pressures induced by therapy (Donlin, M. J., et al., J. Virol. 81, 8211-8224, 2007). The inventors sequenced the complete HCV ORF from 94 patients before therapy, stratified based on response to therapy at day 28 (Marked, Intermediate, or Poor responders) and genotype (1a or 1b). It was found that viral genetic variability in sequences from the marked responders (in whom therapy efficiently suppressed viral titers) was much higher than in the poor responders (in whom suppression of the virus was minimal or absent). These genetic variability differences were found primarily in the viral NS3 and NS5A genes for genotype 1a and in core and NS3 for genotype 1b. Importantly, core, NS3, and NS5A all have functions in cultured cells that can counteract the effect of interferon alpha, the dominant drug during HCV therapy (Gale, M.; and Foy, E. M., Nature 436, 939-945, 2005). Similar results were obtained with the eventual outcome of therapy (Donlin M. J., Cannon, N. A., Aurora, R., Li, J. Wahed, A., Di Bisceglie, A. M., and Tavis, J. E., PLoS One 5, e9032, 2010). It is believed that the association of higher diversity with response to therapy implies that the virus in poor responders survived because there are only a few ways to optimize activity of the viral proteins, but many ways to interfere with their function.

U.S. patent application publication no. 2008/0318207 by the same inventors discloses a method for predicting a response of a virus to therapy. The method relies on identification of one or more covariance pairs that are most connected to other amino acid positions in responder and non-responder alignments of viral isolates, and determining whether the test virus contained these same covariance pairs. Thus, the prior method only looked at one or more single amino acid positions, and the actual amino acids contained therein.

### SUMMARY OF THE INVENTION

The present invention is directed to a computer-implemented method for predicting a response of a test virus to antiviral therapy, which comprises:
a) identifying covariance pairs of amino acid residues independently in reference responder alignment and reference non-responder alignment, wherein the reference responder alignment comprises aligned amino acid sequences of viral isolates responsive to the antiviral therapy, and the reference non-responder alignment comprises aligned amino acid sequences of viral isolates that are not responsive to the antiviral therapy, and wherein the test virus and viral isolates are from the same genus;
b) establishing a reference responder network and a reference non-responder network based on the covariance pairs identified independently in the reference responder and non-responder alignments;
c) aligning an amino acid sequence of the test virus independently to the amino acid sequences of the reference responder alignment and to the amino acid sequences of the reference non-responder alignment, thereby generating a test virus responder alignment and a test virus non-responder alignment;
d) identifying covariance pairs of amino acid residues independently in the test virus responder alignment and the test virus non-responder alignment;
e) establishing a test virus responder network and a test virus non-responder network independently based on the covariance pairs identified in the test virus responder alignment and the test virus non-responder alignment; and
f) predicting the response of the test virus as responding to the antiviral therapy if the difference in OMES score between the test virus responder network and the reference responder network is greater than the difference in OMES score between the test virus non-responder network and the reference non-responder network as would be expected by random chance, and if the difference in a number of hydrophobic pairs between the test virus responder network and the reference responder network is greater than the difference in a number of hydrophobic pairs between the test virus non-responder network and the reference non-responder network as would be expected by random chance, or as not responding to the antiviral therapy if the difference in OMES score between the test virus non-responder network and the reference non-responder network is greater than the difference in OMES score between the test virus responder network and the reference responder network as would be expected by random chance, and if the difference in a number of hydrophobic pairs between the test virus non-responder network and the reference non-responder network is greater than the difference in a number of hydrophobic pairs between the test virus responder network and the reference responder network as would be expected by random chance, wherein the method steps (a)-(f) are implemented by one or more computing devices. The present method can also include steps for determining independently a number of hydrophobic-hydrophobic interaction between the covariant pairs in the reference responder network and non-responder network and for determining a number of hydrophobic-hydrophobic interactions between the covariant pairs independently in the test virus responder network and the test virus non-responder network; wherein both steps can either be performed manually or by one or more computer-implemented devices.

The invention is also directed to one or more computer-readable readable tangible storage media having computer-executable instructions, the instructions comprising:
a) identifying covariance pairs of amino acid residues independently in a reference responder alignment and a reference non-responder alignment, wherein the reference responder alignment comprises aligned amino acid sequences of viral isolates responsive to the antiviral therapy, and the reference non-responder alignment comprises aligned amino acid sequences of viral isolates that are not responsive to the antiviral therapy, and wherein the test virus and viral isolates are from the same genus;
b) establishing a reference responder network and a reference non-responder network based on the covariance pairs identified independently in the reference responder alignment and the reference non-responder alignment;
c) optionally determining independently a number of hydrophobic-hydrophobic interactions between the covariant pairs in the reference responder network and non-responder network;
d) aligning an amino acid sequence of the test virus independently to the amino acid sequences of the reference responder alignment and to the amino acid sequences of the reference non-responder alignment, thereby generating a test virus responder alignment and a test virus non-responder alignment;
e) identifying covariance pairs of amino acid residues independently in the test virus responder alignment and the test virus non-responder alignment;
f) establishing a test virus responder network and a test virus non-responder network independently based on the covariance pairs identified in the test virus responder alignment and the test virus non-responder alignment;
g) optionally determining a number of hydrophobic-hydrophobic interactions between the covariant pairs independently in the test virus responder network and the test virus non-responder network; and
h) predicting the response of the test virus as responding to the antiviral therapy if the difference in OMES score between the test virus responder network and the reference responder network is greater than the difference in OMES score between the test virus non-responder network and the reference non-responder network as would be expected by random chance, and if the difference in a number of hydrophobic pairs between the test virus responder network and the reference responder network is greater than the difference in a number of hydrophobic pairs between the test virus non-responder network and the reference non-responder network as would be expected by random chance, or as not responding to the antiviral therapy if the difference in OMES score between the test virus non-responder network and the reference non-responder network is greater than the difference in OMES score between the test virus responder network and the reference responder network as would be expected by random chance, and if the difference in a number of hydrophobic pairs between the test virus non-responder network and the reference non-responder network is greater than the difference in a number of hydrophobic pairs between the test virus responder network and the reference responder network as would be expected by random chance.

The invention is also directed to a system comprising a processor and one or more computer-readable tangible storage media having computer-executable instructions executable by the processor, the instructions comprising:

an establishing module including computer-executable instructions executable by the processor for:
a) identifying covariance pairs of amino acid residues independently in a reference responder alignment and a reference non-responder alignment, wherein the reference responder alignment comprises aligned amino acid sequences of viral isolates responsive to the antiviral therapy, and the reference non-responder alignment comprises aligned amino acid sequences of viral isolates that are not responsive to the antiviral therapy, and wherein the test virus and viral isolates are from the same genus;
b) establishing a reference responder network and a reference non-responder network based on the covariance pairs identified independently in the reference responder alignment and the reference non-responder alignment;
c) optionally determining independently a number of hydrophobic-hydrophobic interactions between the covariant pairs in the reference responder network and non-responder network;
d) aligning an amino acid sequence of the test virus independently to the amino acid sequences of the reference responder alignment and to the amino acid sequences of the reference non-responder alignment, thereby generating a test virus responder alignment and a test virus non-responder alignment;
e) identifying covariance pairs of amino acid residues independently in the test virus responder alignment and the test virus non-responder alignment;
f) establishing a test virus responder network and a test virus non-responder network independently based on the covariance pairs identified in the test virus responder alignment and the test virus non-responder alignment; a determining module including computer-executable instructions executable by the processor for:
g) optionally determining a number of hydrophobic-hydrophobic interactions between the covariant pairs independently in the test virus responder network and the test virus non-responder network; and
a predicting module including computer-executable instructions executable by the processor for:
h) predicting the response of the test virus as responding to the antiviral therapy if the difference in OMES score between the test virus responder network and the reference responder network is greater than the difference in OMES score between the test virus non-responder network and the reference non-responder network as would be expected by random chance, and if the difference in a number of hydrophobic pairs between the test virus responder network and the reference responder network is greater than the difference in a number of hydrophobic pairs between the test virus non-responder network and the reference non-responder network as would be expected by random chance, or as not responding to the antiviral therapy if the difference in OMES score between the test virus non-responder network and the reference non-responder network is greater than the difference in OMES score between the test virus responder network and the reference responder network as would be expected by random chance, and if the difference in a number of hydrophobic pairs between the test virus non-responder network and the reference non-responder network is greater than the difference in a number of hydrophobic pairs between the test virus responder network and the reference responder network as would be expected by random chance.

In an embodiment, the computer-implemented method is for predicting a response of a Hepatitis C Virus (HCV) isolate to antiviral therapy comprising interferon alpha and ribavirin by
a) identifying covariance pairs of amino acid residues independently in reference responder alignment and reference non-responder alignment, wherein the reference responder alignment comprises aligned amino acid sequences of HCV viral isolates responsive to the antiviral therapy, and the reference non-responder alignment comprises aligned amino acid sequences of HCV viral isolates that are not responsive to the antiviral therapy;
b) establishing a reference responder network and a reference non-responder network based on the covariance pairs identified independently in the reference responder and non-responder alignments;
c) aligning an amino acid sequence of the HCV isolate independently to the amino acid sequences of the reference responder alignment and to the amino acid sequences of the reference non-responder alignment, thereby generating a HCV responder alignment and a HCV non-responder alignment;
d) identifying covariance pairs of amino acid residues independently in the HCV responder alignment and the HCV non-responder alignment;
e) establishing a HCV responder network and a HCV non-responder network independently based on the covariance pairs identified in the HCV responder alignment and the HCV non-responder alignment; and
(f) predicting the response of the HCV isolate as responding to the antiviral therapy if the difference in OMES score between the HCV responder network and the HCV reference responder network is greater than the difference in OMES score between the HCV non-responder network and the HCV reference non-responder network as would be expected by random chance, and if the difference in a number of hydrophobic pairs between the HCV responder network and the HCV reference responder network is greater than the difference in a number of hydrophobic pairs between the HCV non-responder network and the HCV reference non-responder network as would be expected by random chance, or as not responding to the antiviral therapy if the difference in OMES score between the HCV non-responder network and the HCV reference non-responder network is greater than the difference in OMES score between the HCV responder network and the HCV reference responder network as would be expected by random chance, and if the difference in a number of hydrophobic pairs between the HCV non-responder network and the HCV reference non-responder network is greater than the difference in a number of hydrophobic pairs between the HCV responder network and the HCV reference responder network as would be expected by random chance, wherein the method steps (a)-(f) are implemented by one or more computing devices. The present method can also include steps for determining independently a number of hydrophobic-hydrophobic interaction between the covariant pairs in the reference responder network and non-responder network and for determining a number of hydrophobic-hydrophobic interactions between the covariant pairs independently in the test virus responder network and the test virus non-responder network; wherein both steps can either be performed manually or by one or more computer-implemented devices.

Other objects and features will be in part apparent and in part pointed out hereinafter.

### BRIEF DESCRIPTION OF THE DRAWINGS

FIGS. 1A and 1B depict flow diagram and block diagram representations of a computer handling of the data.

FIG. 2 is a graphic representation of a Hepatitis B, genotype B network.

FIGS. 3 and 4 are graphic representations of the algorithm for predicting a viral response to therapy.

FIG. 5 is a graphic representation of an exemplary method used to determine lower threshold and upper threshold values for summing OMES scores in algorithms depicted in FIGS. 3 and 4.

FIG. 6 depicts the effect of increasing the covariance cutoff score on the number of covariances for alignments of natural and scrambled HCV sequences.

FIG. 7 shows a covariance network for the set of 300 Hepatitis C virus 1a sequences. FIG. 7A shows a phylogenetic tree for the HCV 1a sequences. FIG. 7B depicts a network graph, wherein circles represent the amino acid positions (nodes) and the lines (edges) between the nodes represent covariances. The sizes of the nodes are proportional to the number of edges they contact. The HCV polyprotein amino acid number is indicated on nodes that are large enough to contain the number. Clear circles represent structural, and shaded circles represent non-structural positions. FIG. 7C shows the comparison of the number of edges and nodes in the original HCV covariance networks generated from 47 HCV subtype 1a sequences (VHCorfs) and in the new networks generated from 300 1a sequences (300 orfs). FIG. 7D shows degree distribution plot, which was fit to the power-law for the network in panel B.

FIG. 8 shows that randomly associating residue positions do not generate networks similar to the viral covariance networks. FIG. 8A shows networks generated from covariances in control Hepatitis C virus alignment of 300 sequences in which residues at positions of variance were scrambled. FIG. 8B depicts network and degree distribution plot generated from 3199 randomly linked positions, which mimic the number of edges in the alignment of 100 HCV 1a sequences. FIG. 8C shows network and degree distribution plot generated from 208 randomly linked positions, which mimic the number of edges in the alignment of 41 HEV sequences.

FIG. 9 is a graphic representation of the covariance network for the Crimean-Congo Hemorrhagic Fever virus. FIG. 9A depicts the network graph. The node color indicates the viral genomic segment and the node sizes are proportional to the number of edges contacting each node. FIG. 9B depicts the degree distribution plot for the network.

FIG. 10 depicts the covariance network for Influenza virus A. FIG. 10A depicts the network graph. The sizes of the nodes are proportional to the number of edges that they contact. The nodes are color-coded by segment, and the node numbers indicate the position in the concatenated gene alignments. FIG. 10B depicts the degree distribution plot.

FIG. 11 shows the covariance network for Hepatitis B virus genotype B. FIG. 11A depicts the HBV genetic organization in its linear RNA phase. Cap, mRNA cap; pC, pre-C coding region that together with the C sequences encodes the HBeAg; C, core gene; TP, terminal protein domain of the polymerase gene; Spacer, spacer domain of the polymerase; RT, reverse transcriptase domain of the polymerase; RNaseH, RNaseH domain of the polymerase; pS1, the pre-S1 domain of the largest of the three carboxy-coterminal surface proteins; pS2, the pre-S2 domain of surface proteins; SAg, the smallest surface protein (HBsAg); X, X gene; Aₙ, polyadenyl tail. The X and pre-C regions overlap In the circular DNA phase. FIG. 11B depicts the network graph. The sizes of the nodes are proportional to the number of edges they contact, and the node numbers indicate the position in the concatenated gene alignment. FIG. 11C shows the degree distribution plot.

Corresponding reference characters indicate corresponding parts throughout the drawings.

### DESCRIPTION OF THE PREFERRED EMBODIMENTS

The present invention is directed to a method for predicting a response of a virus to antiviral therapy. Briefly, the invention is based on differences in the numbers of covariance pairs and hydrophobic-hydrophobic interactions between covariant pairs as established from calculating such numbers for responding and non-responding virus alignments before and after the inclusion of the test virus. The method is based on the alignment of an amino acid sequence of a virus, for which the response is to be predicted and referred to herein as a “test virus” to amino acid sequences of related responder or non-responder virus isolates, generating corresponding networks based on the covariant pairs, and determining number of hydrophobic-hydrophobic interactions between the covariant pairs. The resulting stabilization or destabilization of the networks due to the inclusion of the test virus' sequence provides information about the virus's ability to respond to the antiviral therapy. As used herein, “responder,” responding, “or susceptible to antiviral therapy” refer to viruses, for which antiviral therapy suppresses viral titers substantially for a prolonged period of time after drug withdrawal, whereas “non-responder,” “non-responding,” “poor responder,” “not susceptible to antiviral therapy” or “resistant to antiviral therapy” refer to viruses, for which antiviral therapy induced minimal or no suppression of viral titers after drug withdrawal. In one embodiment, the antiviral therapy suppresses viral titers for at least six months following drug withdrawal in responder strains.

The methods of the present invention are based on observations with Hepatitis C virus (HCV); however, the present methods are applicable to any virus, which exhibits high genomic variability, is susceptible (responding) to antiviral therapy or is resistant (non-responding) thereto, and is treated with an antiviral therapy that applies a pleiotropic pressure on the virus. Thus, the present invention is applicable, without limitation, to viruses that infect mammals including viruses that infect humans, viruses that infect birds such as the avian influenza virus, and viruses that infect plants. Some non-limiting examples of viruses to which the disclosed techniques can be applied include RNA viruses and DNA viruses, such as: positive-polarity single-stranded RNA viruses including Flaviviridae, such as Yellow fever virus, Dengue virus, West Nile virus, Japanese encephalitis virus, a Hepacivirus such as a Hepatitis C virus, and reverse-transcribing retroviruses such as HIV-1 and HIV-2; negative polarity segmented RNA viruses such as Influenza virus, strains of which infect humans or animals such as birds or swine; negative polarity unsegmented RNA viruses including Paramyxoviridae such as Measles virus, Respiratory Syncytial virus, and Mumps virus, as well as Rhabdoviridae such as rabies virus; positive-polarity single-stranded RNA viruses including Picornaviridae such as rhinovirus (which causes the common cold, and for which over 100 strains are known), Enteroviruses such as Coxsackie virus, Echovirus, Hepatitis A virus, and Foot-and-mouth disease virus; double-stranded segmented RNA viruses, including Rotaviridae; partially double-stranded DNA viruses including Hepadnaviridae such as Hepatitis B virus; mixed positive and negative polarity single-stranded DNA viruses, including Parvoviridae such as Canine and Feline Parvoviruses. In some embodiments, the virus is selected from the group consisting of Hepatitis B virus, Hepatitis C virus, SARS-Coronavirus, Coxsackie viruses, Respiratory Syncytial virus (RSV), Influenza viruses, and Human Immunodeficiency virus (HIV).

Many of the amino acid positions in the HCV and HBV open reading frames vary in concert with other positions in the genome. This concept is referred to as covariance, i.e., covariance refers to coordinated variation of two residues among a collection of related sequences. Thus, “covariance pairs” refer to two amino acid positions that covary among a collection of related sequences.

The amino acid residue positions exhibiting covariance within a biological system, such as a viral genome can be related in a network. The elements of the network are the nodes and edges, wherein the nodes refer to amino acid positions and the edges refer to connections between the nodes. In each network, there are also “hub” amino acid residue positions, wherein each hub exhibits covariance with multiple other amino acid residue positions. As used herein, a hub residue position is a node with 5 or more edges, i.e., a hub amino acid residue position exhibits covariance with at least 5 other amino acid residue positions. The term “spoke” as used herein refers to nodes which exhibit limited covariance, i.e. are connected to four or fewer other nodes. By way of example, HCV networks can generally have a “hub-and-spoke” architecture, with a few nodes (e.g., positions in the alignments) covarying with many others (hubs), but most nodes being connected to only few others (spokes). The responder HCV isolates and poor-responder HCV isolates form discrete genome-wide networks of covarying amino acids pairs, linking the covariance to antiviral therapy response. Furthermore, the non-responders have many more hydrophobic amino acids, such as valine (Val), isoleucine (Ile), leucine (Leu), methionine (Met), phenylalanine (Phe), tryptophan (Trp), tyrosine (Tyr), alanine (Ala) and cysteine (Cys) in the covarying pairs than the responders. Lysine-lysine and argininine-arginine pairs are also considered hydrophobic interactions. Hydrophobic interactions contribute much more to protein stability in an aqueous environment than hydrophilic interactions; thus, while not being bound to a theory, it is believed that the potential for greater stability provided by the higher hydrophobic nature of the interactions may allow some of the viruses in the population to better survive the pressures introduced by the antiviral therapy. As the inventors have discovered, such networks are also useful for determining characteristics of a test virus by comparing it to already established networks based on covariance pairs. As described herein, stabilization or destabilization of a network by the addition of a test virus indicates whether the test virus can be classified in a particular network, and a number of network parameters can be used to determine such classification.

Accordingly, one aspect of the present invention is directed to a computer-implemented method for predicting a response of a test virus to an antiviral therapy, the method comprising:
a) identifying covariance pairs of amino acid residues independently in reference responder alignment and reference non-responder alignment, wherein the reference responder alignment comprises aligned amino acid sequences of viral isolates responsive to the antiviral therapy, and the reference non-responder alignment comprises aligned amino acid sequences of viral isolates that are not responsive to the antiviral therapy, and wherein the test virus and viral isolates are from the same genus;
b) establishing a reference responder network and a reference non-responder network based on the covariance pairs identified independently in the reference responder and non-responder alignments;
c) aligning an amino acid sequence of the test virus independently to the amino acid sequences of the reference responder alignment and to the amino acid sequences of the reference non-responder alignment, thereby generating a test virus responder alignment and a test virus non-responder alignment;
d) identifying covariance pairs of amino acid residues independently in the test virus responder alignment and the test virus non-responder alignment;
e) establishing a test virus responder network and a test virus non-responder network independently based on the covariance pairs identified in the test virus responder alignment and the test virus non-responder alignment; and
f) predicting the response of the test virus as responding to the antiviral therapy if the difference in OMES score between the test virus responder network and the reference responder network is greater than the difference in OMES score between the test virus non-responder network and the reference non-responder network as would be expected by random chance, and if the difference in a number of hydrophobic pairs between the test virus responder network and the reference responder network is greater than the difference in a number of hydrophobic pairs between the test virus non-responder network and the reference non-responder network as would be expected by random chance, or as not responding to the antiviral therapy if the difference in OMES score between the test virus non-responder network and the reference non-responder network is greater than the difference in OMES score between the test virus responder network and the reference responder network as would be expected by random chance, and if the difference in a number of hydrophobic pairs between the test virus non-responder network and the reference non-responder network is greater than the difference in a number of hydrophobic pairs between the test virus responder network and the reference responder network as would be expected by random chance, wherein the method steps (a)-(f) are implemented by one or more computing devices. The present method can also include steps for determining independently a number of hydrophobic-hydrophobic interaction between the covariant pairs in the reference responder network and non-responder network and for determining a number of hydrophobic-hydrophobic interactions between the covariant pairs independently in the test virus responder network and the test virus non-responder network; wherein both steps can either be performed manually or by one or more computer-implemented devices. In some of the embodiments, these two steps are performed after steps (b) and (e), respectively.

In some instances, amino acid sequences of viral isolates which are from the same genus, and more preferably from the same species as the test virus whose response to antiviral therapy is to be predicted, are aligned. Sequences of viral isolates which respond to therapy are aligned to form a reference responder alignment, and sequences of non-responding viral isolates are aligned to form a reference non-responder alignment. In some embodiments, the reference responder alignment contains at least about 5 aligned amino acid sequences from responding viral isolates. More preferably, the reference responder alignment contains from about 5 to about 30 aligned sequences from responding viral isolates. Specifically, it can contain at least about 5, 6, 7, 8, 9, 10, 11, 12, 13, 14, 15, 16, 17, 18, 19, 20, 21, 22, 23, 24, 25, 26, 27, 28, 29 or 30 aligned amino acid sequences from responding viral isolates. In one preferred embodiment, the reference responder alignment contains at least about 15 aligned amino acid sequences from responding viral isolates.

In some embodiments, the reference non-responder alignment contains at least about 5 aligned amino acid sequences from non-responding viral isolates. More preferably, the reference non-responder alignment contains between 5 and 30 aligned sequences from non-responding viral isolates. Specifically, it can contain at least about 5, 6, 7, 8, 9, 10, 11, 12, 13, 14, 15, 16, 17, 18, 19, 20, 21, 22, 23, 24, 25, 26, 27, 28, 29 or 30 aligned amino acid sequences from non-responding viral isolates. In one preferred embodiment, the reference non-responder alignment contains 15 aligned amino acid sequences from non-responding viral isolates. In another embodiment, the reference responder and non-responder alignments each contain at least about 15 aligned amino acid sequences from responding and non-responding viral isolates, respectively.

In some embodiments, the responder viruses are from the same subtype, and a test virus is from the same subtype. In other embodiments, the non-responder viruses are from the same subtype, and the test virus is from the same subtype.

The methods for aligning multiple sequences are well known in the art, and readily available to a skilled artisan. By way of example and not of limitation, multiple sequences can be aligned by using Clustal W (Jeanmougin, F., et al., Trends Biochem. Sci. 23, 403-405, 1998) as previously described (Donlin, M. J., et al., J. Virol. 81, 8211-8224, 2007). Additional programs for aligning multiple amino acid sequences that are known in the art can also be used.

In some embodiments, the sequences of viral isolates are amino acid translations of Hepatitis C virus open reading frame (ORF) sequences, and more preferably, they have either 1a or 1b genotypes, whose sequences are readily available to one of ordinary skill in the art, e.g., through databases such as Genbank. In some instances, the reference responder alignment contains at least 15 amino acid sequences from responding HCV 1a or 1b isolates. In some instances, the reference non-responder alignment contains at least 15 amino acid sequences from non-responding 1a or 1b isolates. These sequences can be obtained, e.g., from Genbank EF407411 to EF407504. In some embodiments, the sequences of viral isolates are amino acid translations of Hepatitis B virus ORF sequences from any of the 8 genotypes (A-H).

When the alignment is performed over partial genomes of viral isolates rather than over the whole genome length, one of ordinary skill in the art can select partial genomes to be used based on characteristics such as proteins which the partial sequences encode, biological importance, sequence identity among different isolates, antiviral therapy that is used, immunological status of a patient, and the like. The partial genomes used for alignment can be at least 1000 amino acids long, and preferably are at least 2100 amino acids long. By way of example and not of limitation, if the viral isolates are from HCV, the partial length of the genome sequences that are aligned can be at least 2045 amino acids. In another exemplary embodiment, the partial HCV genomes that are aligned can span amino acids 380-2425 covering the proteins E1 through NS5A.

Following the alignment, covarying pairs of amino acid positions are identified separately in reference responder and non-responder alignments, wherein the alignments include either full or partial genome sequences. By way of example and not of limitation, three previously published algorithms can be used to identify covarying positions (Olmea, O., et al., J. Mol. Biol. 293, 1221-1239, 1999; Atchley, W. R., et al., Mol. Biol. Evol. 17, 164-178, 2000; Kass, I., and Horovitz, A., Proteins 48, 611-617, 2002). In designing algorithms that measure correlated variations, it is important to favor an intermediate level of conservation because a balance should exist between false positives at non-conserved positions (where a random frequency of amino acids is observed), and false negatives (from positions where residues are completely conserved). The HCV genome contains many positions that are completely conserved, with islands of variable positions. It was previously shown that the observed minus expected square (OMES) method (Kass, I., and Horovitz, A., Proteins 48, 611-617, 2002) provides a good measure of covariance.

In one embodiment of the present invention, a covariance score for every possible pair of positions in each alignment can be calculated by squaring the difference between the number of observed and expected amino acid pairs and normalizing this difference by the number of entries (excluding gaps) in each column (OMES method) (Kass, I., and Horovitz, A., Proteins 48, 611-617, 2002). The null model in this analysis is the expected number of covarying pairs, which is based on the count of each amino acid at each of the two positions of each pair of positions. Therefore, two perfectly conserved columns will have a score of zero because the expected and observed numbers are equal.

To identify the covarying pairs, a score S using observed and expected pairs can be calculated for every possible pair of columns i and j:

$$S = {\sum }_{N = 1}^{N = L} {( {N}_{OBS} - {N}_{EXP} )}^{2} / N$$

where L is the list of all observed pairs and N_{obs} is the number of occurrences for a pair of residues. The expected number for the pair is given by:

N_{EXP}=(CₓᵢC_{yj})/N_{valid}

in which N_{valid} is the number of sequences in the alignment that are non-gap residues, Cₓᵢ is the observed number of residue x at position i, and C_{yj} is the observed number of residues y at position j. The expected number of column pairs calculated in this manner provides a reasonable null model for comparisons of the observed pairs.

In one exemplary embodiment, covarying positions can be defined, e.g., as those pairs with scores greater or equal to 0.5. This corresponds to a difference of at least 3 observed covarying pairs between the observed and expected in an alignment of 16 sequences. While this choice is arbitrary, it provides a reasonable number of comparisons across the phenotype classes.

In one embodiment, an OMES score of 0.5 can be used as the cutoff (threshold) value based on the foregoing analysis. In other embodiments, a different OMES score can be calculated if a difference other than at least 3 observed covarying pairs between the observed and expected is used. Following identification of covarying pairs, such information can be used to establish networks. In one embodiment, the networks can be established by representing the covarying pairs as graphs, where a graph is a collection of nodes (amino acid positions) connected by edges (represented as lines) if they display covariance.

Alternatively, the present algorithm can be used by summation of all OMES scores rather than by summation of OMES scores above a threshold value.

In one exemplary embodiment, graphs can be generated for the covarying positions using Cytoscape (Shannon, P., et al., Genome Res. 13, 2498-2504, 2003). Alternatively, other graphing methods can be used to establish networks, including but not limited to AllegroGraph, Commetrix, Gephi, Graph-tool and the like. For additional programs, see, e.g., http://en.wikipedia.org/wiki/Social_network_analysis_software.

In one embodiment, a reference responder network is based on graphing covariant pairs identified from a reference responder alignment and connections among the various pairs, whereas a reference non-responder network is based on graphing covariant pairs identified from a reference non-responder alignment and their connections. In one preferred embodiment, a reference responder network is based on graphing covariant pairs identified from a HCV reference responder alignment and connections among the various pairs, whereas a reference non-responder network is based on graphing covariant pairs identified from a HCV reference non-responder alignment and their connections. In another preferred embodiment, a reference responder network is based on graphing covariant pairs identified from a HCV genotype 1a reference responder alignment based on sequences of, e.g., 15 HCV 1a responding isolates and connections among the various pairs, whereas a reference non-responder network is based on graphing covariant pairs identified from a HCV 1a reference non-responder alignment based on sequences of, e.g., 15 HCV 1a non-responding isolates and their connections. In still another preferred embodiment, a reference responder network is based on graphing covariant pairs identified from a HCV genotype 1b reference responder alignment based on sequences of, e.g., 15 HCV 1b responding isolates and connections among the various pairs, whereas a reference non-responder network is based on graphing covariant pairs identified from a HCV 2b reference non-responder alignment based on sequences of, e.g., 15 HCV 1b non-responding isolates and their connections. In still another embodiment, a reference responder network is based on graphing covariant pairs identified from a HBV reference responder alignment based on sequences of, e.g., 15 HBV responding isolates and connections among the various pairs, whereas a reference non-responder network is based on graphing covariant pairs identified from a HBV reference non-responder alignment based on sequences of, e.g., 15 HBV non-responding isolates and their connections.

In addition to establishment of networks, the present method also includes determination of a number of hydrophobic-hydrophobic interactions between covariant pairs in the reference responder network and reference non-responder network. The determination can be done in networks or in alignments after identifying covariant pairs since the networks are graphic representations of covariant pairs in alignments, and thus have the same covariant pairs. As is known in the art, hydrophobic amino acids include alanine, valine, isoleucine, leucine, methionine, phenylalanine, tryptophan, tyrosine, and cysteine. Furthermore, lysine-lysine and arginine-arginine pairs are also considered hydrophobic interactions. Depending on the size of the network, the number of hydrophobic-hydrophobic interactions between covariant pairs can be counted manually or using computer-implemented programs. For example, a computer program can be linked to the network to determine which position pairs to count in order to obtain the number of hydrophobic-hydrophobic interactions between covariant pairs.

Following this, the effects of a test virus on the responder and non-responder networks are determined. In one embodiment, a test virus is HCV. In another embodiment, the test virus is HCV isolated from a patient, and preferably is an HCV genotype 1, 2, 3, 4, 5 or 6, such as genoypes 1a, 1b, 1c, 2a, 2b, 2c, 3a, 3b, 4a, 4b, 4c, 4d, 4e, 5a and 6a. Preferably, HCV type is 1a, 1b, 2a, 2b, or 3a. In some embodiments, the test virus is a Hepatitis B virus, such as any of the genotypes A, B, C, D, E, F or H. In still other embodiments, a test virus is HIV or influenza; however, any of the viruses mentioned in the foregoing sections can be used.

The virus can be obtained from a patient using any of the standard methods in the art, such as by obtaining a sample of venous blood via venopuncture. Serum samples can then be analyzed for presence of a virus, e.g., by nested PCR techniques, ELISAs, or strip-western blots. Preferably, the patient is a human. Once the test virus is obtained, it is sequenced using any of the known methods in the art. By way of example and not of limitation, ABI dye-terminated technology, 454 Pyrosequencing, or Illumina sequencing can be used to sequence test viruses.

Next, the sequence of the test virus is aligned independently to the sequences contained in the reference responder and non-responder alignments by adding the sequence of the test virus independently to the sequences contained in the reference responder and non-responder alignments. In one preferred embodiment, an amino acid sequence of the HCV test virus isolated from a patient is added to 15 amino acid sequences from HCV 1a reference responder alignment, and to 15 amino acid sequences from HCV 1a reference non-responder alignment. In another preferred embodiment, the sequence of HCV test virus isolated from a patient is added to 15 sequences from HCV 1b reference responder alignment, and to 15 sequences from HCV 1b reference non-responder alignment. In still other embodiments, the sequence of HIV or HBV test virus isolated from a patient is added to 15 sequences from HIV or HBV reference responder alignment, and to 15 sequences from HIV or HBV reference non-responder alignment, respectively. This addition of the test virus sequence generates new alignments, referred to herein as a test virus responder alignment and a test virus non-responder alignment. Covariant pairs are again identified in the test virus responder and non-responder alignments, and test virus responder and non-responder networks are established. Covariant pair identification and network generation are performed using the same methods discussed in the above sections. Similarly, the number of hydrophobic-hydrophobic interactions in test virus responder and non-responder networks is again determined using the same methods as described above.

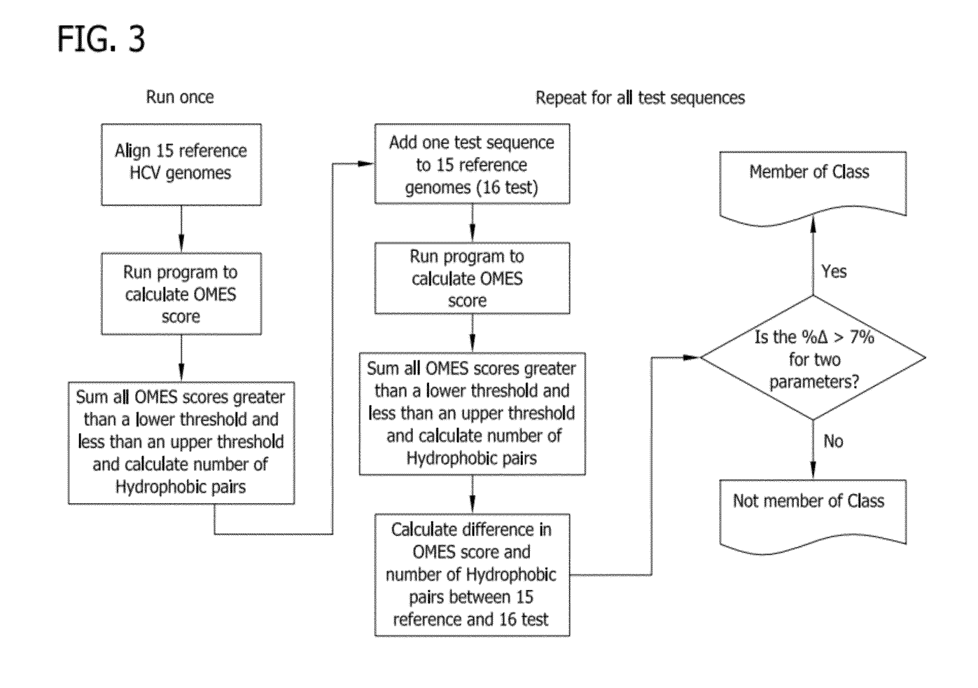

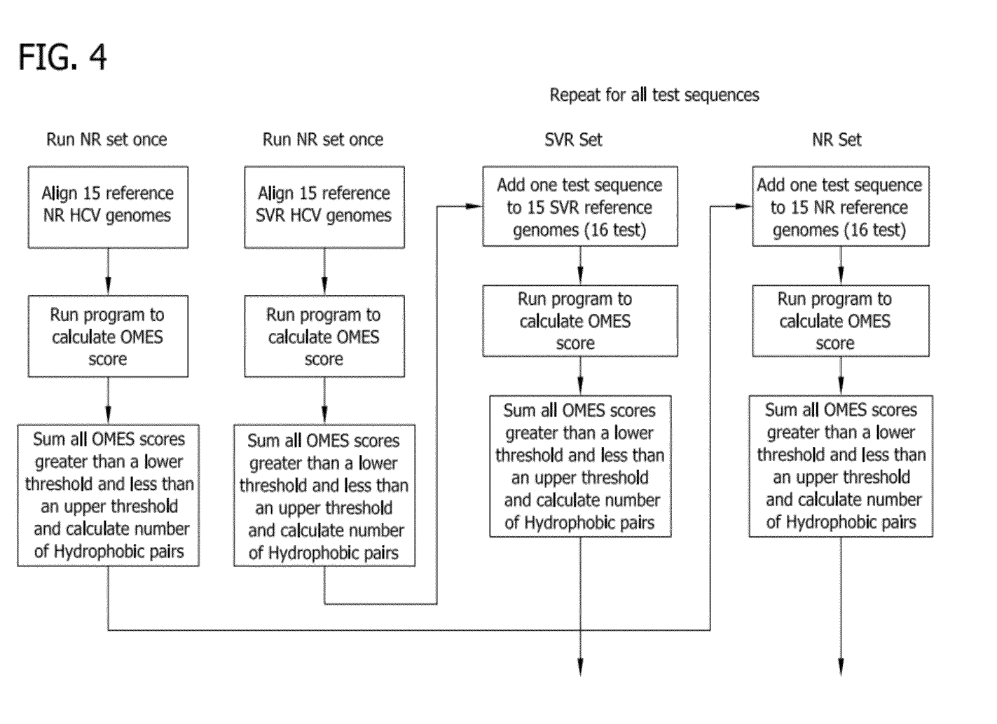

The comparison of the difference in covariant pairs and hydrophobic interactions between reference responder network and test virus responder network and separately between reference non-responder network and test virus non-responder network allows for prediction of the test virus to antiviral therapy. The difference that is measured is not a set number but depends on a number of factors, such as sample size (how many sequences in an alignment), the length of the alignment, the average OMES score within the alignment, the hydrophobic residue density, and the like. One of ordinary skill in the art can readily determine the appropriate difference for a particular virus and alignment size. For example, if a test virus is added to 15 sequences in an alignment, a 6.7% ( 1/15) change by random chance is expected. Thus, getting a 10% difference, e.g., between the number of covariant pairs between the test virus responder network and reference responder network, indicates a significant result, a “signal strength” above random chance. The general and more specific schemes for the algorithm are shown below. It will be readily apparent to a skilled artisan that a significant difference can be easily determined once the number of reference sequences to be used is selected. The general algorithm scheme is shown in FIG. 3, whereas the specific algorithm scheme is shown in FIG. 4.

In one embodiment, the algorithm only makes predictions about a viral response in two cases based on the following formula.
IF
   OMES Score (16 SVR−15 SVR ref)>1.07*(16 NR−15 NR ref) AND Hydrophobic pairs (16 SVR−15 SVR ref)>1.07*(16 NR−15 NR ref)
Then call test sequence SVR
ELSE IF:
   OMES Score (16 NR−15 NR ref)>1.07*(16 SVR−15 SVR ref) AND Hydrophobic pairs (16 NR−15 NR ref)>1.07*(16 SVR−15 SVR ref)
Then call test sequence NR
ELSE:
   call test sequence UNDETERMINATE

In the shown algorithm and in FIGS. 3 and 4, NR designates a non-responder, SVR stands for “sustained release responder” or “responder” to indicate responder viruses, whose viral load decreases with therapy and stays low. With respect to HCV, SVR refers to a virus responding to therapy such that there is undetectable virus 6 months following termination of therapy. For purposes of illustration only, the algorithm depicts a difference of greater than 107%, based on the delta that is greater than what would be expected by random chance for addition of 1 sequence to 15 (6.7%). In other applications of the algorithm, this number can readily be determined by a skilled artisan based on the number of viral sequences that are used.

First, if the difference in OMES score between the test virus responder network and the reference responder network is greater than the difference in OMES score between the test virus non-responder network and the reference non-responder network as would be expected by random chance, and if the difference in a number of hydrophobic pairs between the test virus responder network and the reference responder network is greater than the difference in a number of hydrophobic pairs between the test virus non-responder network and the reference non-responder network as would be expected by random chance, the algorithm predicts that the test virus will respond to antiviral therapy. Second, if the difference in OMES score between the test virus non-responder network and the reference non-responder network is greater than the difference in OMES score between the test virus responder network and the reference responder network as would be expected by random chance, and if the difference in a number of hydrophobic pairs between the test virus non-responder network and the reference non-responder network is greater than the difference in a number of hydrophobic pairs between the test virus responder network and the reference responder network as would be expected by random chance, the algorithm predicts that the test virus will not respond to antiviral therapy. For all other combinations of differences in OMES scores and numbers of hydrophobic pairs, the algorithm makes no predictions.

The accuracy of the present algorithm can be improved by eliminating OMES scores below a lower threshold and above an upper threshold for edges that are common to certain data sets generated from sequences where the response outcome is known. Using this approach for responder sequences, a first set of sequences form a responder reference set. Preferably, the responder reference set includes at least 15 sequences for known responders. A second set of sequences is used to construct a “responder reference set+1 responder sequence” data set. Preferably, at least 15 sequences are included in the second set. Each sequence of the second set is aligned with the sequences of the responder reference set, covariance pairs are calculated, and a network is generated as described above. The alignment, calculation of covariance pairs and generation of a network are repeated such that a number of networks equal to the number of sequences in the second set are generated. A third set of sequences is used to construct a “responder reference set+1 non-responder sequence” data set. Preferably, at least 15 sequences are included in the third set. Each sequence of the third set is aligned with the sequences of the responder reference set, covariance pairs are calculated, and a network is generated as described above. The alignment, calculation of covariance pairs and generation of a network are repeated such that a number of networks equal to the number of sequences in the third set are generated. For a single test virus, networks are generated for a “responder reference set+1 responder sequence” data set, and for a “responder reference set+1 non-responder sequence” data set. For example, if the second and third sets of sequences include x sequences for responders and y sequences for non-responders, x networks are generated for a “reference set+1 responder sequence” data set, and y networks are generated for a “reference set+1 non-responder sequence” data set. The edges of each of the networks in the “responder reference set+1 responder sequence” data set and the “responder reference set+1 non-responder sequence” data set each have a corresponding calculated OMES score. A computer program is used to determine the number of times that an OMES score occurs across edges in both the responder reference set+1 responder sequence” data set and the “responder reference set+1 non-responder sequence” data set. The lowest OMES score for which edges from both data sets occur is the upper threshold for the responder OMES scores.

Likewise, the same approach is used for non-responder sequences. A first set of sequences form a non-responder reference set. Preferably, the non-responder reference set includes at least 15 sequences for known non-responders. A second set of sequences is used to construct a “non-responder reference set+1 responder sequence” data set. Preferably, at least 15 sequences are included in the second set. Each sequence of the second set is aligned with the sequences of the non-responder reference set, covariance pairs are calculated, and a network is generated as described above. The alignment, calculation of covariance pairs and generation of a network are repeated such that a number of networks equal to the number of sequences in the second set are generated. A third set of sequences is used to construct a “non-responder reference set+1 non-responder sequence” data set. Preferably, at least 15 sequences are included in the third set. Each sequence of the third set is aligned with the sequences of the responder reference set, covariance pairs are calculated, and a network is generated as described above. The alignment, calculation of covariance pairs and generation of a network are repeated such that a number of networks equal to the number of sequences in the third set are generated. For a single test virus, networks are generated for a “non-responder reference set+1 responder sequence” data set, and for a “non-responder reference set+1 non-responder sequence” data set. The edges of each of the networks in the “non-responder reference set+1 responder sequence” data set and the “non-responder reference set+1 non-responder sequence” data set each have a corresponding calculated OMES score. A computer program is used to determine the number of times that an OMES score occurs across edges in both the “non-responder reference set+1 responder sequence” data set and the “non-responder reference set+1 non-responder sequence” data set. The lowest OMES score for which edges from both data sets occur is the upper threshold for the non-responder OMES scores.

The edges of each of the networks in the “responder reference set+1 responder sequence” data set and the “non-responder reference set+1 responder sequence” data set are then analyzed via a computer program to determine the number of times that an OMES score occurs across edges in both of these data sets. The lowest OMES score for which edges from both data sets occur is the lower threshold for the responder OMES scores.

The edges of each of the networks in the “responder reference set+1 non-responder sequence” data set and the “non-responder reference set+1 non-responder sequence” data set are then analyzed via a computer program to determine the number of times that an OMES score occurs across edges in both of these data sets. The lowest OMES score for which edges from both data sets occur is the lower threshold for the non-responder OMES scores.

Increased accuracy of the present algorithm is achieved by summation of only the OMES scores that are greater than the lower threshold and less than the upper threshold for the responders and nonresponders as shown in FIGS. 3 and 4.

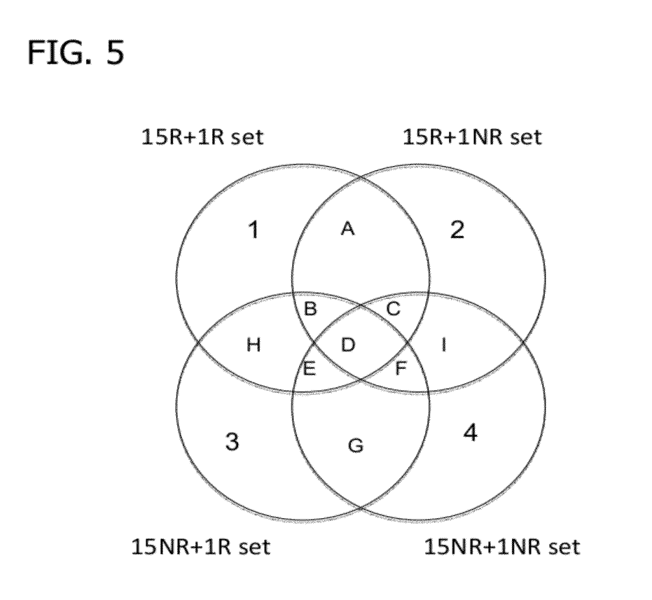

For example, the method of increasing the accuracy of the present algorithm is depicted in the Venn diagram of FIG. 5. A first set of 15 sequences form a responder reference set 15R. A second set of 15 sequences is used to construct a 15R+1R data set. Each sequence of the second set is aligned with the 15R sequences, covariance pairs are calculated, and a network is generated as described above. The alignment, calculation of covariance pairs and generation of a network are repeated such that 15 networks are generated for the 15R+1R class. A third set of 15 sequences is used to construct a 15R+1 NR data set. Each sequence of the third set is aligned with the 15R sequences, covariance pairs are calculated, and a network is generated as described above. The alignment, calculation of covariance pairs and generation of a network are repeated such that 15 networks are generated for the 15R+1 NR class. The edges of each of the 15 networks in the 15R+1R data set and the edges of each of the 15 networks in the 15R+1 NR data set are represented as circle 1 and circle 2 in FIG. 5, and each of the edges has a corresponding calculated OMES score (not shown). In this example, 92% of the edges of these two data sets occurred in both data sets, and the edges occurring in both data sets are depicted as the overlapping portion of circles 1 and 2 (i.e., areas A, B, C and D). A computer program is used to determine the number of times that an OMES score occurs across these edges in both data sets. The lowest OMES score for which edges from both data sets occur is the upper threshold for the responder OMES scores, and in this example, was determined to be 0.8. Likewise, a first set of 15 sequences form a non-responder reference set 15NR. Second and third sets of 15 sequences are used to construct 15NR+1R and 15 NR+1NR data sets. The edges of each of the 15 networks in the 15NR+1R data set and the edges of each of the 15 networks in the 15NR+1 NR data set are represented as circle 3 and circle 4 in FIG. 5, and each of the edges has a corresponding calculated OMES score (not shown). In this example, 92% of the edges of these two data sets occurred in both data sets, and the edges occurring in both data sets are depicted as the overlapping portion of circles 3 and 4 (i.e., areas D, E, F and G). A computer program is used to determine the number of times that an OMES score occurs across these edges in both data sets. The lowest OMES score for which edges from both data sets occur is the upper threshold for the non-responder OMES scores, and in this example, was determined to be 0.8. The edges of each of the 15 networks in the 15R+1R data set and the 15NR+1R data set are then analyzed via a computer program to determine the number of times that an OMES score occurs across edges in both of these data sets. The lowest OMES score for which edges from both data sets occur is the lower threshold for the responder OMES scores, and in this example, was determined to be 0.4. In this example, 3.4% of the edges of these two data sets occurred in both data sets, and the edges occurring in both data sets are depicted as the overlapping portion of circles 1 and 3 (i.e., areas B, D, E and H). Area H represents the edges used in determining the lower threshold for responders, and areas B, D and E represent the edges with corresponding OMES scores used in determining the upper thresholds as described above. The edges of each of the 15 networks in the 15R+1NR data set and the 15NR+1NR data set are then analyzed via a computer program to determine the number of times that an OMES score occurs across edges in both of these data sets. The lowest OMES score for which edges from both data sets occur is the lower threshold for the non-responder OMES scores, and in this example, was determined to be 0.4. In this example, 3.4% of the edges of these two data sets occurred in both data sets, and the edges occurring in both data sets are depicted as the overlapping portion of circles 2 and 4 (i.e., areas C, D, F and I). Area I represents the edges used in determining the lower threshold for non-responders, and areas C, D and F represent the edges with corresponding OMES scores used in determining the upper thresholds as described above. Improved discrimination is achieved by summation of only the OMES scores that are greater than the lower threshold and less than the upper threshold for the responders and nonresponders as shown in FIGS. 3 and 4.

The upper thresholds or lower thresholds for responders and non-responders are not necessarily the same value. These OMES scores would be expected to vary when any asymmetry arises in response to therapy (i.e. the response to therapy is not 50%) or if multiple virus types are found in patient population.

One of ordinary skill in the art would be able to determine the upper and lower thresholds for responders and non-responders for any virus being tested based on the general description and specific example provided above.

Accordingly, the present algorithm can be used to accurately predict a response of a test virus to antiviral therapy. In one preferred embodiment, the present algorithm can be used to predict a response of HCV isolated from a patient to therapy consisting of interferon alpha and ribavirin, or interferon alpha alone. In another embodiment, the present algorithm can predict a response of HBV isolated from a patient to therapy consisting of either interferon alpha alone, or any combination of interferon alpha and nucleos(t)ide analogs. In a number of embodiments, the present algorithm can be used to predict a viral response to direct acting agents that can be used in combination with interferon alpha, or with interferon alpha and ribavarin. For information on direct acting agents, for HCV see, e.g., Thompson A J, McHutchison J G: Antiviral resistance and specifically targeted therapy for HCV (STAT-C). J Viral Hepat 2009, 16:377-387; Lemon et al.: Development of novel therapies for hepatitis C. Antiviral Res 2010, 86:79-92, and Enomoto et al.: Emerging antiviral drugs for hepatitis C virus. Rev Recent Clin Trials 2009, 4:179-184.

The method of the present invention finds particular use in determining the appropriate therapy for a patient. As some of the available antiviral therapies have serious side effects and can be extremely costly, it would be of great advantage to both a clinician and patient if they could know before starting the therapy whether the patient will respond or not. For instance, the method can be used to determine whether a patient with Hepatitis C will respond to therapy of interferon alpha and ribavirin or not. As the method is non-invasive and simple (since it only requires sequencing of the partial or full genome of a patient's virus), it provides additional advantages for its application in clinical settings.

### EXAMPLES

The following non-limiting examples are provided to further illustrate the present invention.

The methods described herein utilize laboratory techniques well known to skilled artisans, and guidance can be found in laboratory manuals such as Sambrook, J., et al., Molecular Cloning: A Laboratory Manual, 3rd ed. Cold Spring Harbor Laboratory Press, Cold Spring Harbor, N.Y., 2001; Spector, D. L. et al., Cells: A Laboratory Manual, Cold Spring Harbor Laboratory Press, Cold Spring Harbor, N.Y., 1998; and Harlow, E., Using Antibodies: A. Laboratory Manual, Cold Spring Harbor Laboratory Press, Cold Spring Harbor, N.Y., 1999, and textbooks such as Hedrickson et al., Organic Chemistry 3rd edition, McGraw Hill, New York, 1970; Carruthers, W., and Coldham, I., Modern Methods of Organic Synthesis (4th Edition), Cambridge University Press, Cambridge, U.K., 2004. Networks and network theory are discussed in references such as Barabasi, A.-L., Linked: The new science of networks, Perseus Publishing, Cambridge, Mass., 2002; Newman et al. The Structure and Dynamics of Networks, Princeton University Press, 2006; Watts, D. J., Six degrees: The science of a connected age, W. W. Norton & Company, 2003; Watts, Duncan J. Small Worlds: The Dynamics of Networks between Order and Randomness. Princeton University Press, 1999.

### Hepatitis B Network Data

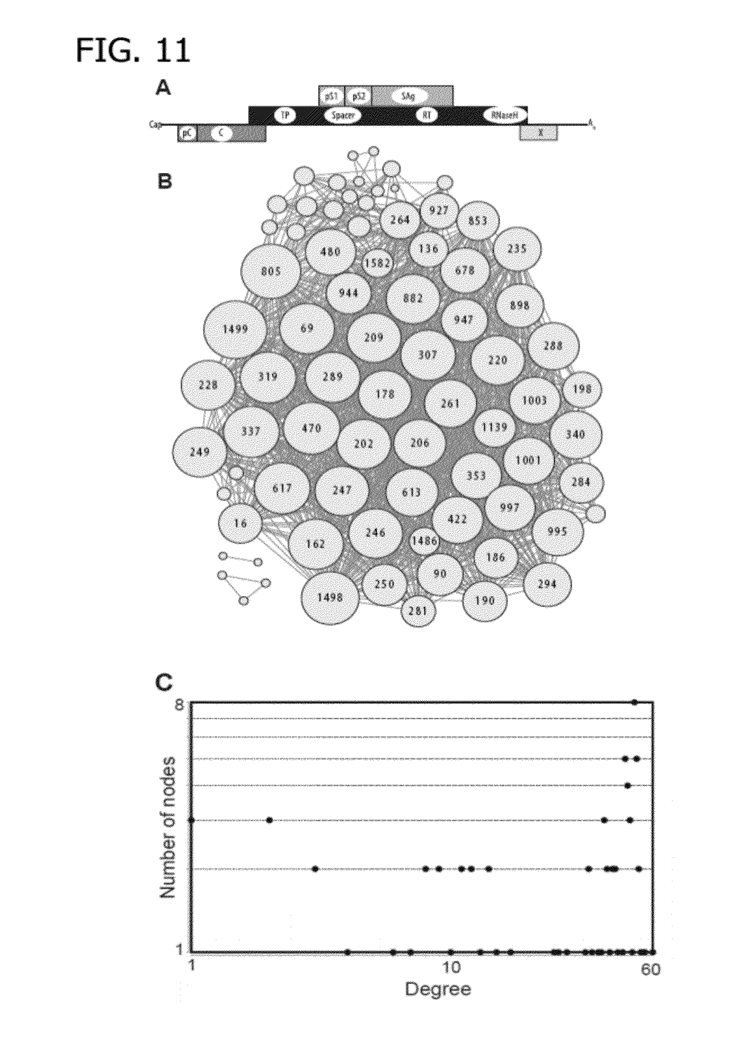

HBV is as a reverse-transcribing virus with adequate genetic diversity to support covariance analysis [it has eight genotypes that differ from each other by >8% {Schaefer, S., World J. Gastroenterology, 13, 14-21, 2007]. Its ˜3,200 nt circular DNA genome is remarkably compact, with all nucleotides code for protein and over half of them in two frames simultaneously {Seeger C, Zoulim F, Mason WS. Hepadnaviruses. In: Knipe D M, Howley P, Griffin D E, Lamb R A, Martin M A, Roizman B, et al., eds. Fields Virology. 5 ed. Philadelphia: Lippincott Williams & Wilkins, 2007. 2977-3029}. Hepatitis B virus (HBV) was examined because it is a partially double-stranded DNA virus with adequate genetic diversity. Furthermore, over half of its genome encodes two proteins simultaneously in overlapping frames (FIG. 11A), and this unusual genetic organization may have impacted its intra-genomic genetic interactions.

One hundred independent full genome sequences were obtained for each HBV genotypes B, C, and D. The amino acid sequences for each of the viral genes were extracted from their overlapping genomic positions and compiled into a single string for each viral isolate. The 100 sequences for each genotype were then aligned, yielding collinear alignments with mean pairwise identities of about 97%. All covariances within the genome were identified using the OMES method at a 1% false-discovery rate, and then pseudo-covariances stemming from changes to a single nucleotide affecting overlapping codons were manually eliminated.

About 5% of the HBV amino acid positions covaried with ≧1 other position, as shown in TABLE 1.

TABLE 1
Summary of HBV covariances.

| Parameter | Genotype B | Genotype C | Genotype D |
|---|---|---|---|
| Total number | 1303 | 1616 | 1255 |
| Intergenic | 43% | 49% | 60% |

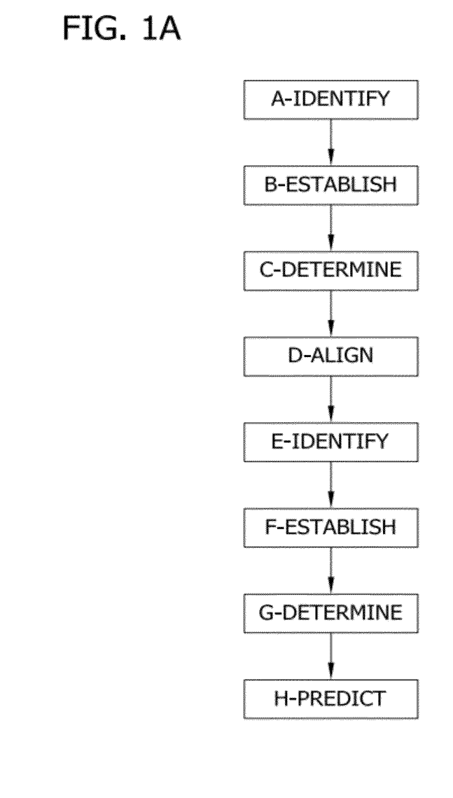

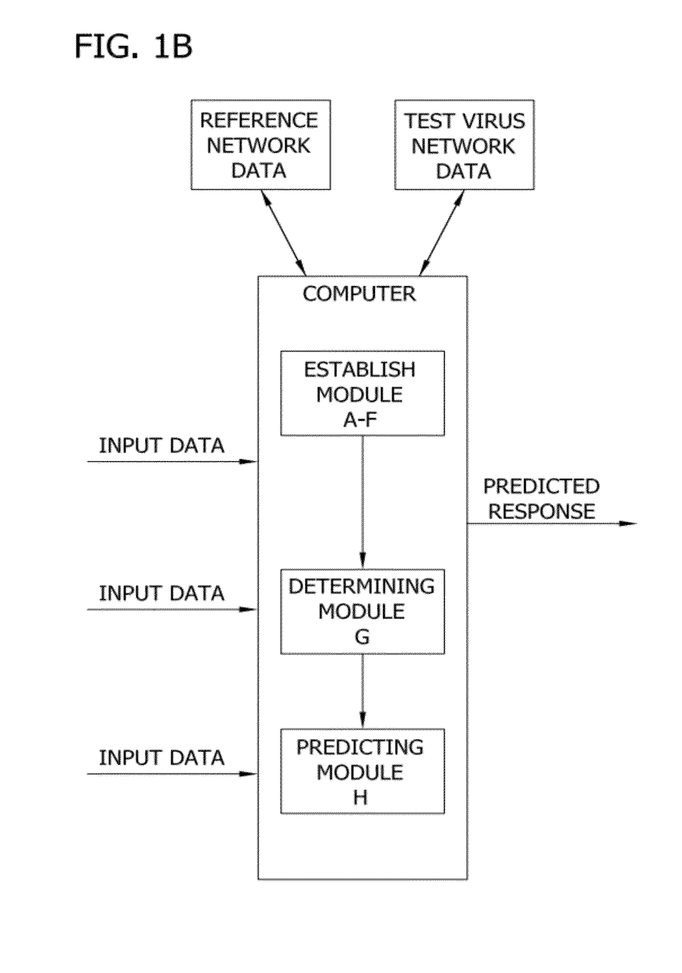

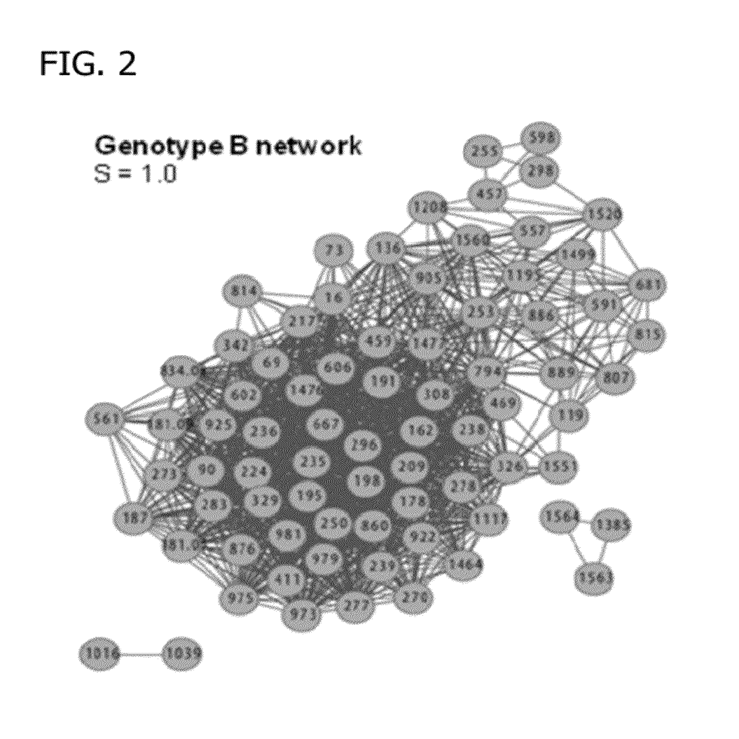

The large majority (83-92% depending on genotype) of the covariances involved the viral reverse transcriptase, which accounts for approximately half of the viral coding potential. Approximately half of the covariances were intergenic, indicating that like the other viruses, there are many selective pressures that affect more than one viral protein at a time. Furthermore, the covariances formed intact networks that contained most of the covariances for each of the three genotypes (FIG. 1 and Table 2).

TABLE 2
HBV network characteristics

| Genotype | Nodes | Edges/Node | γ | R² |
|---|---|---|---|---|
| A | 78 | 33.6 | 0.02 | 0.001 |
| B | 106 | 30.8 | 0.146 | 0.048 |
| C | 89 | 28.2 | 0.10 | 0.172 |

The value of g was obtained from fitting to the power law distribution:
log(Pr(k))=−γ log(k); R² is the correlation coefficient for the fit.

Each of the three HBV covariance sets formed a single network with high density that contained most of all the covariances (FIG. 11B). The degree distribution plots for these networks failed to fit to the power-law (FIG. 11C), again due to a large number of highly connected nodes leading to a random topology (Table 5). As with the other DNA virus that were examined, the HBV network metrics were comparable to the metrics for the majority of RNA viruses. This supports the concept that genome-wide covariance networks are a common feature of viral genomes, regardless of their physical structure.

The networks all had an unusual architecture, with most nodes were very tightly interconnected, and a smaller set of nodes being less densely interconnected in each network, indicating that the HBV covariance network architecture was neither hub-and-spoke, hierarchical, nor point-to-point. This covariance network analysis indicates that just like HCV, the amino acid covariances found within the HBV genome reflected the sum of the selective pressures on the virus and hence could be used to integrate information relevant to antiviral pressures whose effects are distributed across viral proteins or other functions encoded throughout the viral genome.

### Example 2

### Presence of Amino Acid Covariance in Diverse Viral Families

### Materials and Methods

Sequence acquisition and curation. Sequences for all viruses examined were obtained from the NIAID Virus Pathogen Resource Database and Analysis Resource (http://www.viprbrc.org). Sequences from naturally occurring isolates were used whenever possible by eliminating strains identified as lab-adapted or vaccine-derived in the Genbank record. If a subset of the total number of acceptable sequences was used, the sequences were randomly selected. All sequences were confirmed to be independent either by reciprocal BLASTP analysis or importing the alignment into ToPali and using the summary information function (Milne et al., 2009. TOPALi v2: a rich graphical interface for evolutionary analyses of multiple alignments on HPC clusters and multi-core desktops. Bioinformatics. 25:126-127).

All sequences in these analyses were collinear to maintain a consistent numbering system, so infrequent insertions were manually deleted. The first open reading frame in the Hepatitis E virus (HEV) sequences contains a polyproline stretch of ˜52 amino acids that failed to align and was hence removed from the covariance analyses. The first 240 residues of the Crimean-Congo Hemorrhagic Fever virus (CCHV) M segment contain a stretch of variable, mucin-like repeats that failed to align, so this repetitive sequence was removed. All alignments were analyzed in ToPali and neighbor-joining phylogenetic trees were generated (F84/WAG+G with 30 bootstrap runs).

Sequence alignments and covariance identification. Alignments for use in the covariance algorithm were generated using MUSCLE and exported in msf format (Edgar, R. C. 2004. MUSCLE: a multiple sequence alignment method with reduced time and space complexity. BMC. Bioinformatics. 5:113). Covariant positions in the sequence alignments were identified by applying the observed-minus-expected-squared (OMES) approach to all possible pairs of amino acid positions as described herein. To identify the covarying pairs, for every possible pair of columns i and j, a score S was calculated using observed and expected pairs:

$$S = \frac{{\sum }_{1}^{L} {( {N}_{OBS} - {N}_{EXP} )}^{2}}{{N}_{valid}}$$

where L is the number of observed pairs and N_{obs} is the number of occurrences for a pair of residues. The expected number for the pair is given by:

$${N}_{EXP} = \frac{{C}_{xi} {C}_{yj}}{{N}_{valid}}$$

N_{valid} is the number of sequences in the alignment that are non-gap residues, Cₓᵢ is the observed number of residue x at position I, and C_{yj} is the observed number of residues y at position j. The expected number of column pairs calculated in this manner provided a null model for comparisons of the observed pairs.

To determine the cutoff score for S to use for each alignment, the number of covarying pairs was plotted over a range of scores. This curve was compared to a similar curve generated from alignments of sequences in which the residues at positions of variance were shuffled, and the score cutoff at which the number of covarying pairs in the shuffled alignment was ≦1% of the number of covarying pairs in the unshuffled alignment was used to define the covariances.

Network analysis. Networks were generated from the covariance lists as previously described (Aurora et al., 2009. Genome-wide hepatitis C virus amino acid covariance networks can predict response to antiviral therapy in humans. J. Clin. Invest. 119:225-236). The covariance scores were converted to a simple interaction file (SIF) format at the chosen OMES score cut-off using a python script. Network views were generated using Cytoscape (Shannon et al., 2003. Cytoscape: a software environment for integrated models of biomolecular interaction networks. Genome Res. 13:2498-2504) and basic topological parameters were determined using the Cytoscape plug-in Network Analyzer (Assenov et al., 2008. Computing topological parameters of biological networks. Bioinformatics. 24:282-284).

Structural mapping and evaluation of selective pressures. Positions of covariance were plotted using the PyMol Molecular Graphics System, version 1.3 on the DV env (PDB 1TG8), NS3 helicase (PDB 2BMF), and NS5 (PDB 2P3L) proteins, the PV1 capsid (PDB 1HXS), 3C protease (PDB 1L1N) and 3D RNA polymerase (PDB 1RA6) proteins, and on the reverse transcriptase domain molecular model (Das et al., 2001. Molecular modeling and biochemical characterization reveal the mechanism of hepatitis B virus polymerase resistance to lamivudine (3TC) and emtricitabine (FTC). J. Virol. 75:4771-4779) of the Hepatitis B virus polymerase. Selective pressures on codons in selected viral genomes were evaluated using the single likelihood ancestor counting method (Pond, S. L. and S. D. Frost. 2005. Datamonkey: rapid detection of selective pressure on individual sites of codon alignments. Bioinformatics. 21:2531-2533) method with HKY85 nucleotide substitution bias model as implemented at DataMonkey website (www.datamonkey.org).

Standardization of the covariance definition. To establish a consistent definition of covariance applicable to the wide range of viruses in Table 4, a number of covariances that would occur by chance in a given alignment of sequences was identified, and then this pattern was used to define the covariance score cut-off at which the number of chance covariances was ≦1% of the total number of covariances in the alignment.

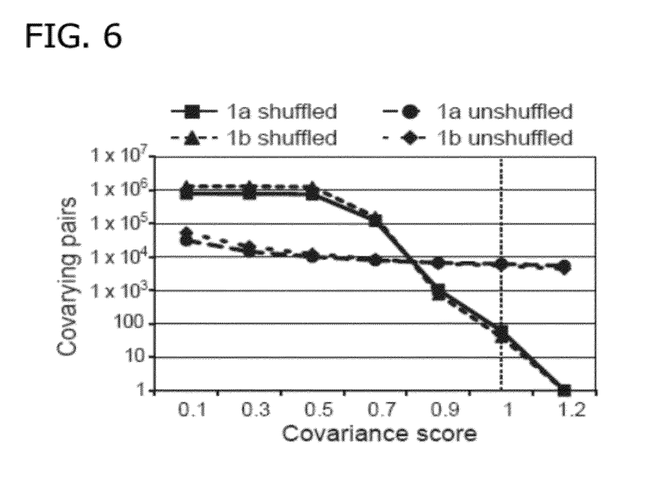

To establish the number of random covariances expected in an alignment of a given set of sequences, the amino acids were extracted at the variable positions in the alignment, the order of the extracted residues was shuffled, and the amino acids were reinserted into their source sequence at positions of variance. The shuffled sequences were forced into a co-linear alignment with the original alignment, covariance scores were calculated for all possible amino acid pairs, and the number of covarying pairs at increasing score cutoff values was plotted. FIG. 6 shows these plots for alignments of 300 HCV subtype 1a and 1b sequences and their shuffled controls. Shuffling the variable positions would be predicted to disrupt high-scoring, biologically relevant covariances and increase the number of low scoring pairs that occurred by chance. As predicted, very many covariances were detected in the shuffled alignments at low scores and the number of covarying pairs dropped rapidly within the score cutoff range of 0.7-0.9. Many fewer covariances were found in alignments of natural sequences at low cutoff scores, but there were many more high-scoring pairs than in the shuffled alignments. At a covariance score of 1.0 the number of covarying pairs in the alignments of HCV 1a and 1b shuffled sequences was 5.1% of the number of covariances for the corresponding unshuffled alignments, yielding a false discovery rate of ≦1%. This procedure was used to define the covariances in all subsequent alignments, and in all cases a score cutoff of approximately 1.0 was used.

HCV covariance networks. The presence of networks among the covariances in alignments of the 300 randomly-selected HCV 1a and 1b sequences was assessed using Cytoscape as previously described for the Virahep-C HCV sequences (Aurora et al., 2009. Genome-wide hepatitis C virus amino acid covariance networks can predict response to antiviral therapy in humans. J. Clin. Invest. 119:225-236). About 10% of the residue positions in the new alignments covaried with one or more other positions, with high average covariance scores for the 1a network (S=4.9 compared to a cutoff value of S=1.0) and moderate average scores for 1b (S=2.3) (Table 5).

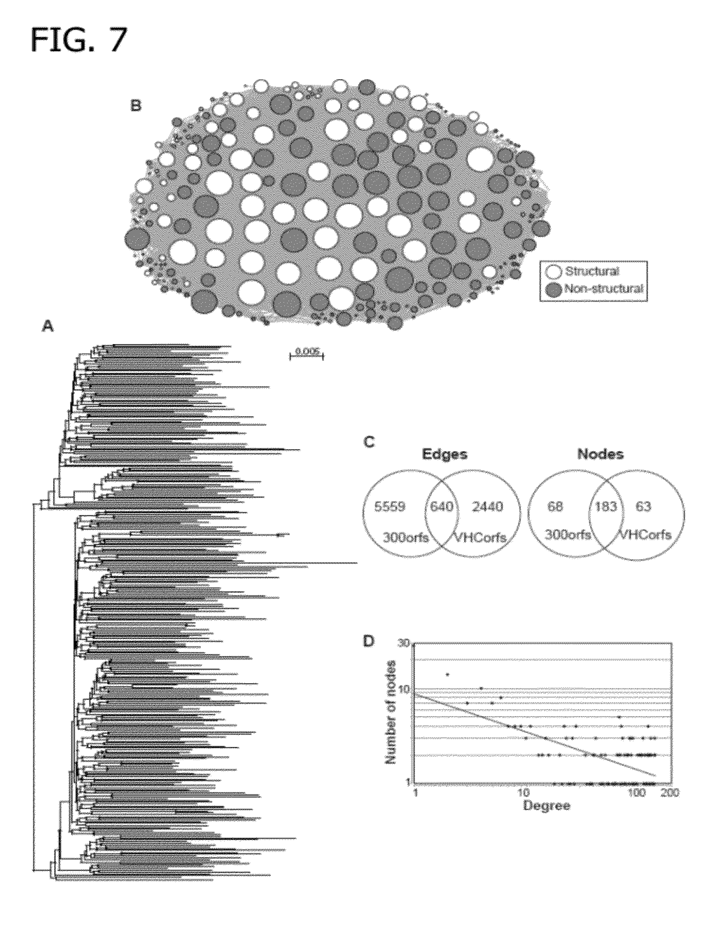

The covariance sets each formed a single network that contained >99% of the covariances (FIG. 7B). The network extended throughout the viral coding region, with similar numbers of covarying positions in the structural and non-structural genes. The networks had relatively low density, relatively high heterogeneity, and low characteristic path lengths [Table 5; definitions of the metrics are in (Christensen, C. and R. Albert. 2007. Using graph concepts to understand the organization of complex systems. International Journal of Bifurcation and Chaos 17:2201-2214; Christensen, C. and R. Albert. 2007. Using graph concepts to understand the organization of complex systems. International Journal of Bifurcation and Chaos 17:2201-2214)]. The majority of the nodes (covarying positions) in these networks overlapped with the nodes in the previously described Virahep-C networks, but the overlap in the edges (covarying pairs) was smaller (FIG. 7C). This was expected because the larger number of sequences increased detection power for covariances, whereas the number of covarying positions remained relatively constant because the number of positions at which variance (and hence potential covariance) exists is limited. The degree (number of edges per node) distribution plot for the HCV subtype 1a and 1b networks followed the inverse power-law (FIG. 7D), where the probability that any node has k edges is given by: P(k)=−γ log(k) (1,5). The γ value was 0.40 for subtype 1a and 0.59 for 1b (Table 5), indicating that both networks had hub-and-spoke topologies in which there were no discrete sub-domains.

Effect of sequence number on the covariance networks. Overall, the network formed from 300 HCV 1a sequences was very similar to the networks formed from 16, 32, 47, or 100 randomly selected sequences as measured by key network metrics including formation of a single network, density, heterogeneity, centralization, average clustering coefficient, characteristic path length, γ value, and topology (Table 3).

TABLE 3
Network characteristics for HCV subtype 1a alignments of varying sizes.

| | | | | | | | | | Charac- | | |
|---|---|---|---|---|---|---|---|---|---|---|---|
| | Residue | Covarying | Average | | | | | Average | teristic | | |
| Alignment | positions | pairs | covariance | Average | | | | clustering | path | Power law | |
| size | (Nodes) | (Edges) | score | connectivity | Density | Heterogeneity | Centralization | coefficient | length | coefficient | Topology |
| 16 | 109 | 712 | 1.4 | 13.1 | 0.12 | 1.05 | 0.30 | 0.46 | 2.5 | 0.56 | Hub & |
| | | | | | | | | | | | spoke |
| 32 | 152 | 1206 | 1.8 | 15.9 | 0.11 | 1.15 | 0.30 | 0.41 | 2.9 | 0.67 | Hub & |
| | | | | | | | | | | | spoke |
| 47 | 171 | 1416 | 1.7 | 16.6 | 0.10 | 1.11 | 0.27 | 0.38 | 2.7 | 0.70 | Hub & |
| | | | | | | | | | | | spoke |
| 100 | 195 | 3199 | 3.0 | 32.8 | 0.17 | 1.01 | 0.39 | 0.59 | 2.2 | 0.42 | Hub & |
| | | | | | | | | | | | spoke |
| 300 | 251 | 6226 | 4.9 | 49.6 | 0.21 | 0.94 | 0.37 | 0.64 | 2.2 | 0.40 | Hub & |
| | | | | | | | | | | | spoke |

These characteristics were also shared by the network formed from an alignment of 300 non-Virahep-C subtype 1b sequences (Table 5). Therefore, the basic network characteristics were identified from rather small sequence sets, and the major effect of increasing the number of sequences from 16 to 300 was to obtain greater sensitivity in identifying covariances, with a concomitant increase in average connectivity and density. Consequently, for the remaining analyses 100 randomly-selected sequences were employed if more than 100 were available, or all sequences if fewer than 100 were available. While not being bound to a particular theory, it is believed that this approach will exhibit higher success rates if the sequences are representative of the viral genomes in circulation (which is unknown in most cases), and if greater confidence is placed in metrics for networks derived from larger data sets.

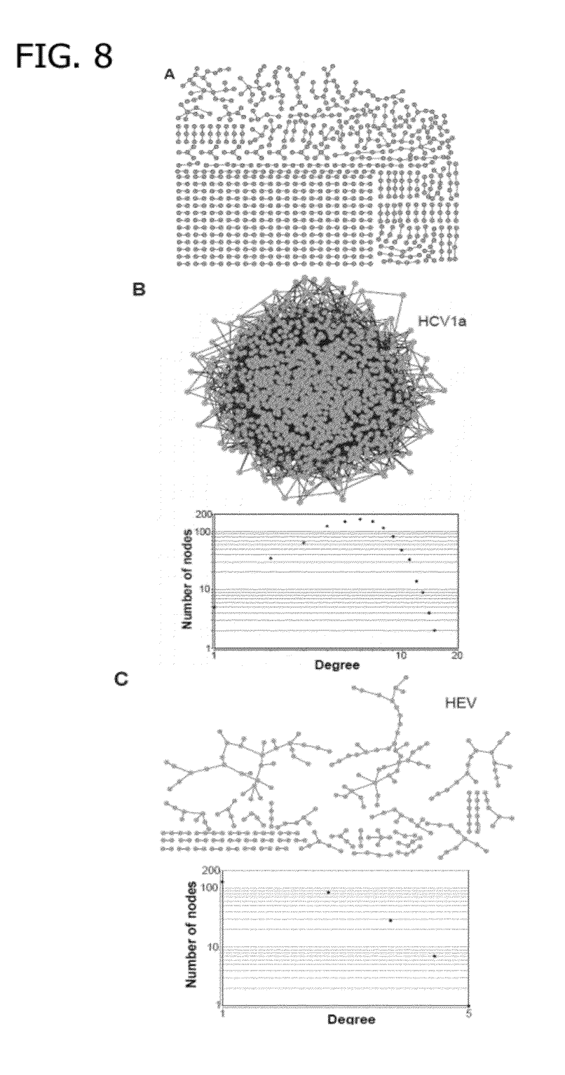

Evaluation of the possibility that the networks may be computational artifacts. The possibility that the covariance networks may have been an artifact of our computational approach was evaluated in two manners. First, the 807 nodes and 543 edges were graphed in the shuffled control alignment of 300 HCV 1a sequences at a covariance cutoff value of S=0.9 (FIG. 8A). The largest network formed by these irrelevant covariances contained only 22 nodes. Furthermore, the overall density of this set of irrelevant networks was 0.001 and their average connectivity was 1.3, compared to a density of 0.21 and average connectivity of 49.6 for the intact network formed from the natural sequences. Similar results were obtained when biologically irrelevant covariances from alignments of randomized sequences for other viruses that were graphed (data not shown). Second, 3199 random associations among the 994 variable positions were generated in the HCV 1a alignments of 100 sequences to mimic the number of covariances in an alignment of 100 HCV 1a sequences. These pairings created an intact network that looked superficially like the natural networks (FIG. 8B), but the network metrics revealed it to be fundamentally different. The degree plot formed a smooth arc rather than a descending line, it had many more nodes (994 vs. 195), and much lower connectivity (6.4 vs. 32.8), density (0.006 vs. 0.17), centralization (0.009 vs. 0.39), and average clustering coefficient (0.007 vs. 0.59) than the natural network. 208 random associations of residues were created among the variable positions in the Hepatitis E virus (HEV) alignment to mimic the number of covariances in the HEV network (FIG. 8C and below). This random covariance set failed to form a network. Therefore, formation of a single network containing the vast majority of the covariances in the viral genomes as observed for all viruses examined here was not an artifact of chance.

Levels of information revealed by covariance analyses. This example with HCV showed the three levels of increasing complexity in covariance network analyses. The first level addresses the pairwise interactions (covariances), including their number and strength (S value). For HCV, about 10% of the positions covaried with relatively high S values that are indicative of relatively strong genetic linkages (typically S=2-5, compared to a cutoff of S=1.0 for a ≦1% false-discovery rate). The second level of complexity is the network connectivity, characterized by whether the covariances link together into a network, the number of independent networks formed, and the density of the network connections. For HCV, this is characterized by the presence of a single network with a modest density. The highest level of complexity is network topology, which describes patterns among the connections within a network and is most easily discerned from the degree distribution plot. For HCV, the topology was non-hierarchical hub-and-spoke, implying that residues found at the most highly connected nodes have a very strong influence on the identity of residues at the lesser-connected nodes. Although hub-and-spoke networks strongly predominate in biology, other topologies, such as linear, star-shaped, and random are possible.

Covariances in other flaviviruses. The assessment of viral covariance networks was expanded to three other members of the Flaviviridae family. GBV-C is a parenterally-transmitted lymphotropic virus that is moderately related to HCV, whereas Dengue virus (DV) and West Nile virus (WNV) are insect-vectored flaviviruses distantly related to HCV. Full-genome sequences [GBV-C, n=27; DV Type 2, n=100; and WNV, n=64] were downloaded and confirmed to be independent. The amino acid sequences for each sequence set were aligned, covariances were identified at a false-discovery rate of ≦1%, and the presence of networks among the covariances was evaluated as described above.

The number of covarying positions in the alignments for these three viruses ranged from 26 (0.75% of the positions) in WNV to 82 positions in GBV-C (2.9% of the positions) (Table 5). This was primarily due to differences in the average pairwise identity in the alignments, with an R² value of 0.93 for the inverse linear relationship between the number of nodes and percent identity. The average covariance scores for these viruses were 1.9, 4.0, and 2.9 for GBV-C, DV and WNV, respectively, in part due to the increasing sensitivity associated with larger sequence sets.

The covarying pairs for DV-2 were mapped onto all available protein crystal structures for this virus. Ten covariant positions were within the env structure, eight were in the NS3 helicase structure and two were in the NS5 structure. All of these positions covaried with other positions in the same protein and also with positions in other proteins. All of these covariant positions were on solvent-accessible surfaces of the proteins, and none of the residues in intra-protein pairs were close enough to bind directly to each other.

Like HCV, each of the other flavivirus covariance sets formed a single genome-wide network containing almost all of the covariances, with many positions from both the structural and non-structural genes. All three of these networks were more dense than the HCV networks (Table 5). Unlike the HCV networks, the degree distribution plot of these networks revealed a large proportion of highly connected nodes. Consequently, these plots did not follow the power-law, and the networks were less heterogeneous than the HCV networks (Table 5). While not being bound to a particular theory, this is believed to indicate that the networks formed by GBV-C, DV, and WNV had random topologies in which there were no discernable patterns among the node connections instead of the hub-and-spoke topology of the HCV network. Therefore, genome-wide covariance networks appear to be widespread in the Flaviviridae, with the size of the networks being affected by the average genetic distance among the viral sequences.

Covariances in other single-stranded positive-polarity RNA viruses. Networks were evaluated in four additional single-stranded positive-polarity RNA viruses, three with unsegmented genomes (Hepatitis A virus, HAV; Poliovirus type 1, PV1; and HEV), and one with a tripartite segmented genome (Crimean-Congo Hemmorrhagic Fever virus, CCHV) (Table 4). HAV is a picornavirus for which 33 independent genomes were analyzed. PV1 is a picornavirus for which 63 full-ORF sequences were identified. Unlike the other viruses, all of the PV1 sequences were descended from the vaccine strains rather than primary field isolates. HEV is a hepevirus for which 41 genomes could be analyzed, and CCHV is a bunyavirus for which 24 independent genomes could be assessed.

TABLE 4
Viruses employed.

| | | | | | | | | | | Avg. |
|---|---|---|---|---|---|---|---|---|---|---|
| | | | | | | | | Genome | Coding | pairwise |
| | | | | | Genome | Genome | Number of | size | capacity | identity |
| Virus species | Abbreviation | Genotype | Family | Genus | structure | segments | sequences | (bp) | (aa) | (%) |
| Hepatitis C | HCV | 1a | Flaviviridae | Hepacivirus | SS RNA, + | 1 | 300 | 9,033 | 3011 | 94.9 |
| virus | | 1b | | | polarity | | 300 | 9,030 | 3010 | 94.2 |
| GB virus C | GBV-C | | Flavirviridae | unassigned | SS RNA, + | 1 | 27 | 9,392 | 2842 | 96.6 |
| | | | | | polarity | | | | | |
| Dengue virus | DV | 2 | Flaviviridae | Flavivirus | SS RNA, + | 1 | 100 | 10,173 | 3391 | 98.2 |
| | | | | | polarity | | | | | |
| West Nile | WNV | | Flaviviridae | Flavivirus | SS RNA, + | 1 | 64 | 11,000 | 3448 | 98.9 |
| virus | | | | | polarity | | | | | |
| Hepatitis A | HAV | | Picornaviridae | Hepativirus | SS RNA, + | 1 | 33 | 7,478 | 2228 | 98.2 |
| virus | | | | | polarity | | | | | |
| Poliovirus | PV | 1 | Picornaviridae | Enterovirus | SS RNA, + | 1 | 63 | 7,441 | 2209 | 97.7 |
| | | | | | polarity | | | | | |
| Hepatitis E | HEV | 3 | Hepeviridae | Hepevirus | SS RNA, + | 1 | 41 | 7,176 | 2432¹ | 97.8 |
| virus | | | | | polarity | | | | | |
| Crimean- | CCHV | | Bunyaviridae | Nairovirus | SS RNA, + | 3 | 24 | 19,146 | 5871² | 94.8 |
| Congo | | | | | polarity | | | | | |
| Hemorrhagic | | | | | | | | | | |
| Fever virus | | | | | | | | | | |
| Rabies virus | RV | 1 | Rhabdoviridae | Lyssavirus | SS RNA, − | 1 | 26 | 11,932 | 3600 | 95.8 |
| | | | | | polarity | | | | | |
| Hepatitis delta | HDV | 1 | unassigned | Deltavirus | SS RNA, − | 1 | 75 | 1,680 | 195³ | 85.1 |
| virus | | | | | polarity | | | | | |
| Influenza virus | IV-A | A | Orthomyxoviridae | Influenza | SS RNA, − | 8 | 32 | 13,400 | 4555 | 99.1 |
| | | | | virus A | polarity | | | | | |
| Parvovirus B19 | B19 | 2 | Parvoviridae | Erythrovirus | SS DNA, | 1 | 20 | 5,594 | 1452 | 98.0 |
| | | | | | mixed | | | | | |
| | | | | | polarity | | | | | |
| Hepatitis B | HBV | B | Hepadnaviridae | Orthohepadnavirus | Partially | 1 | 100 | 3,221 | 1609 | 97.3 |
| virus | | C | | | double- | | 100 | 3,215 | 1609 | 95.9 |
| | | D | | | stranded | | 100 | 3,182 | 1587 | 97.1 |
| | | | | | DNA | | | | | |

¹Coding sequences for CDS1 were edited to remove the repetitive region.
²Coding sequence for the M segment were edited to remove the highly first 240 aa.
³Small form of the HDV delta antigen.

Thirty-seven residue positions that covaried with one or more other positions were identified for HAV (1.75% of the positions), 99 covariant positions were found for PV1 (4.5% of the positions), 50 covariant positions were found for HEV (2.1% of the positions), and 432 positions covaried in CCHV (7.4% of the positions) (Table 5).

TABLE 5
Covariance network characteristics for all viruses examined.

| | | | | | | | | | | Charac- | Power | |
|---|---|---|---|---|---|---|---|---|---|---|---|---|
| | | Residue | Covarying | Average | | | | | Average | teristic | law | |
| Virus | | positions | pairs | covariance | Average | | Hetero- | Centrali- | clustering | path | coeffi- | |
| network | Genotype | (Nodes) | (Edges) | score | connectivity | Density | geneity | zation | coefficient | length | cient | Topology |
| Hepatitis C | 1a | 251 | 6226 | 4.9 | 49.6 | 0.21 | 0.94 | 0.37 | 0.64 | 2.2 | 0.40 | Hub & |
| virus¹ | | | | | | | | | | | | spoke |
| | 1b | 328 | 5589 | 2.3 | 34.1 | 0.10 | 0.96 | 0.36 | 0.46 | 2.3 | 0.59 | Hub & |
| | | | | | | | | | | | | spoke |
| GB virus C | | 82 | 1011 | 1.9 | 24.6 | 0.30 | 0.71 | 0.33 | 0.65 | 2.1 | NA² | Random |
| Dengue virus | 2 | 56 | 427 | 4.0 | 15.2 | 0.27 | 0.58 | 0.27 | 0.75 | 2.2 | NA | Random |
| West Nile | | 26 | 115 | 2.9 | 8.8 | 0.35 | 0.59 | 0.44 | 0.76 | 1.8 | NA | Random |
| virus | | | | | | | | | | | | |
| Hepatitis A | | 37 | 335 | 3.0 | 18.1 | 0.50 | 0.44 | 0.32 | 0.84 | 1.6 | NA | Random |
| virus | | | | | | | | | | | | |
| Poliovirus | 1 | 99 | 1736 | 2.6 | 35.1 | 0.36 | 0.43 | 0.34 | 0.77 | 1.8 | NA | Random |
| Hepatitis E | 3 | 50 | 208 | 2.0 | 8.3 | 0.17 | 0.88 | 0.29 | 0.53 | 2.5 | NA | Random |
| virus³ | | | | | | | | | | | | |
| Crimean- | | 432 | 16595 | 1.5 | 76.8 | 0.18 | 0.62 | 0.29 | 0.66 | 2.1 | NA | Random |
| Congo | | | | | | | | | | | | |
| Hemorrhagic | | | | | | | | | | | | |
| Fever virus⁴ | | | | | | | | | | | | |
| Rabies virus | 1 | 166 | 2541 | 1.7 | 30.6 | 0.19 | 0.73 | 0.32 | 0.62 | 2.4 | NA | Random |
| Hepatitis | 1 | 37 | 128 | 1.6 | 7.0 | 0.19 | 0.61 | 0.27 | 0.39 | 2.2 | NA | Random |
| Delta virus | | | | | | | | | | | | |
| Influenza | A | 50 | 671 | 2.6 | 26.1 | 0.55 | 0.43 | 0.28 | 0.81 | 1.4 | NA | Random |
| virus | | | | | | | | | | | | |
| Parvovirus | 2 | 45 | 485 | 1.5 | 21.4 | 0.49 | 0.45 | 0.37 | 0.83 | 1.6 | NA | Random |
| B19 | | | | | | | | | | | | |
| Hepatitis B | B | 78 | 1303 | 2.5 | 33.4 | 0.43 | 0.57 | 0.35 | 0.81 | 1.7 | NA | Random |
| virus | C | 104 | 1616 | 4.7 | 31.1 | 0.30 | 0.65 | 0.31 | 0.70 | 2.1 | NA | Random |
| | D | 89 | 1255 | 2.3 | 28.2 | 0.32 | 0.49 | 0.32 | 0.74 | 1.9 | NA | Random |

¹Networks formed from 300 sequences for each subtype.
²NA; Not applicable because the correlation coefficient for the power law calculation was below 0.5.
³Coding sequences for CDS1 were edited to remove the repetitive region.
⁴Coding sequences for the M segment were edited to remove the highly variable first 240 aa.

The mean covariance scores for PV1, HAV, and HEV were moderate (S=2.6, 3.0, and 2.0, respectively), but weak for CCHV (S=1.5). Again, the percent of the genome that was covariant was inversely proportional to the mean pairwise identity in the alignments, and the modest average covariance scores for HAV, HEV, and CCHV were partially due to the relatively small number of sequences available.

The 51 positions forming 254 covariances within the VP1, VP2, VP3, VP4, 3C, and 3D proteins were mapped onto the available crystal structures. All of these positions covaried both with positions in the same protein and in other proteins. Similar to what was found for HCV and DV2, all of these covariant positions were on solvent-accessible surfaces of the proteins. Thirty-five of 254 covariances (13.8%) of the residues in intra-protein pairs were close enough to potentially bind directly to each other (≦516 Å between α-carbon atoms). The availability of the full PV1 capsid structure (Hogle et al., 1985. Three-dimensional structure of poliovirus at 2.9 A resolution. Science 229:1358-1365) allowed us to evaluate the higher-order organization of covariant residues in the VP1-4 proteins. There were 217 covariances between 29 residues within or between the capsid proteins for which we could evaluate 1953 possible intra- or inter-capsomere interactions. Twenty-three of the 29 covariant positions representing 25 out of 217 covariances (11.5%) were close enough to possibly touch their covariant partner in at least one of their potential intra-capsid interactions. Nine of these covariances were between different capsid proteins. Eighteen of them were between residues within the same capsomere, five crossed the 3-fold axis of symmetry, and two crossed the 5-fold axis of symmetry. These 25 covariances formed five subnetworks, four of which overlapped the receptor binding site on the capsid.

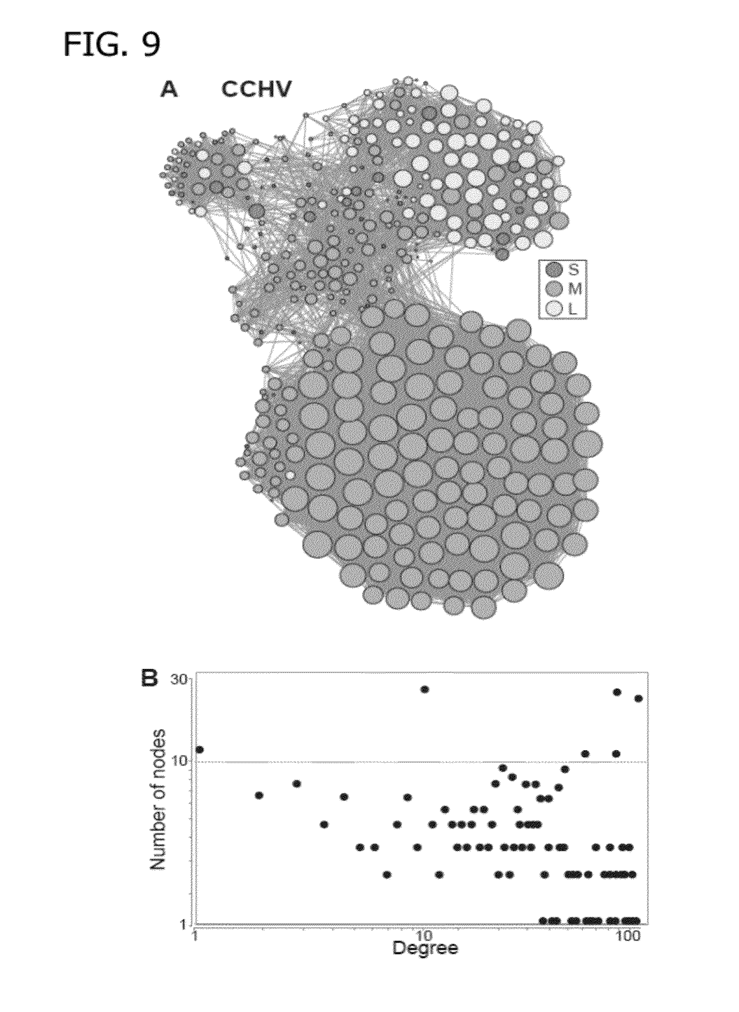

The covariances for HAV, PV1, HEV, and CCHV each formed a single network that contained all or nearly all of the covariant position and that included residues from both the structural and nonstructural regions of the genomes (FIG. 9). The HAV and PV1 networks were relatively dense, but the HEV and CCHV networks had low densities (Table 5). All four degree distribution plots failed to follow the power-law due to a large number of highly-connected nodes, leading to random network topologies. The CCHV network had clear subnetworks which were largely coincident with the genomic segments (FIG. 9). Therefore, all positive-polarity single-stranded RNA viruses examined had extensive networks of intra-genomic genetic dependencies extending through their structural and non-structural genes.

Covariances in single-stranded negative-polarity RNA viruses. Three negative-polarity single-stranded RNA viruses were examined next, two unsegmented (Rabies virus, RV; and Hepatitis Delta virus, HDV), and one segmented (Influenza A virus, IV-A) (Table 4). RV is a rhabdovirus for which we 26 genomes from independent field isolates were analyzed, and HDV is an unassigned viroid-like satellite virus for which 75 genotype 1 genomes could be assessed. IV-A is an orthomyxovirus which shows substantial time-dependent genetic variation as variants are replaced on an annual basis. Preliminary analyses of the available IV-A sequences revealed deep phylogenetic splits, the latest of which corresponded to sequences collected before 2005, and covariance analyses using the entire data set revealed patterns dominated by the time-dependent phylogenetic divides. Consequently, the analysis was restricted to 32 sequences from samples collected at geographically diverse sites between 2005 and 2009 plus one sample collected in 2003 that clustered with the later sequences.

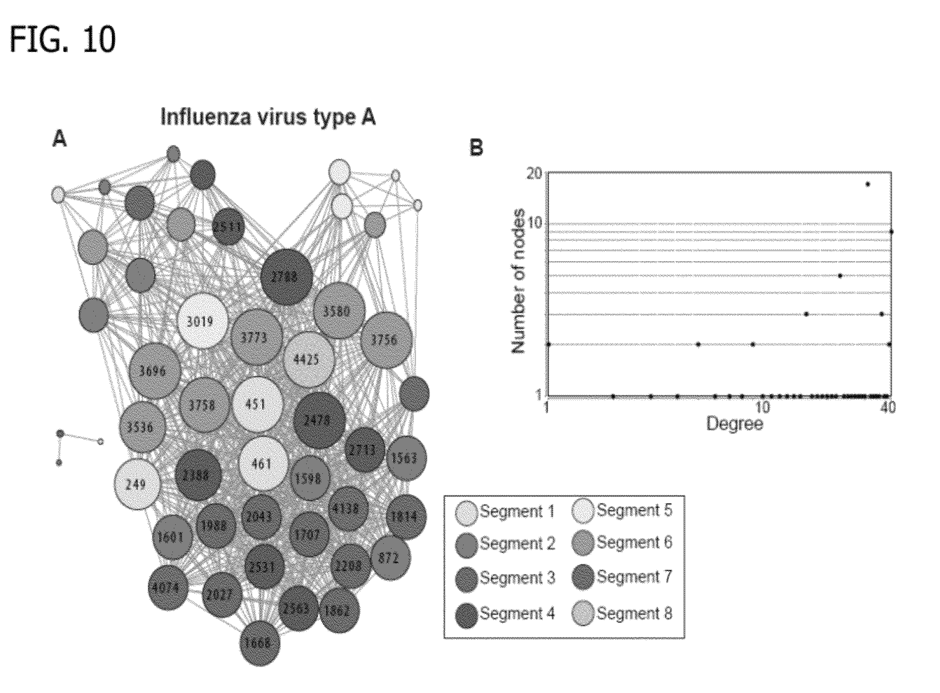

The RV alignments had 166 covariant positions (6.2% of the coding positions), 37 covariant positions were found for HDV (19% of the positions), and 50 were found for IV-A (1.1% of the positions), with the mean covariance scores being moderate for IV-A and weak for RV and HDV (S=2.6, 1.7, and 1.6, respectively) (Table 5). As before, an inverse relationship was observed between the average pairwise identity in the alignments and the proportion of the viral positions that were covariant. Again, each of the covariance sets formed a single genome-wide network that contained essentially all of the covariant positions (FIG. 10). As with the other viruses, the networks contained many positions from both the structural and non-structural genes (HDV encodes a single protein that functions both in RNA replication and as a virion component). The IV-A networks had a high density, whereas the RV and HDV networks had relatively low densities (Table 5). The degree distribution plots for these three networks did not follow the power law. The low number of nodes in the HDV network made unambiguous characterization of its topology difficult, but it appeared to be random. The RV and IV-A networks both had random topologies, and the IV-A network had weakly-defined subnetworks (Table 5, FIG. 10).

Therefore, covariance networks in negative-polarity virus genomes resembled the networks in most of the positive-polarity RNA viruses in that each network was genome-wide, included most of covariances in a single network, and had a random topology. The subnetworks in the IV-A network were less distinct than the subnetworks formed by the other segmented virus (CCHV), and they were not coincident with the viral genetic segments. Therefore, although segmentation of a viral genome may influence the intra-genomic genetic associations reflected in the networks, it is not necessarily a dominant factor.

Covariances in a single-stranded mixed-polarity DNA virus. Parvovirus B19 has a small single-stranded DNA genome in which both the plus- or minus-polarity strands can be packaged into virions (Table 4). 20 independent sequences for which covariance analyses could be conducted were identified. The 485 covariances between 45 nodes in these alignments had a low average covariance score of S=1.5 and formed a single network comprised of 3.1% of the 1452 viral amino acids. The network contained many covarying residues from both the structural and non-structural genes, and it had a high density (Table 5). The degree distribution plot did not follow the power-law, again due to a large proportion of highly connected nodes leading to a random network topology. Overall, the network parameters for the B19 network were similar to the parameters observed for the majority of the RNA viruses that were examined, including average connectivity, density heterogeneity, clustering coefficient, characteristic path length, and topology (Table 5). While not being bound to a particular theory, this indicates that covariance networks can exist in DNA viruses if they have sufficient genetic diversity, and hence genome-wide amino acid covariance networks are not solely a property of RNA viruses.

Thus, as can be seen from the foregoing examples, Intact, genome-wide covariance networks were found in all 16 viruses examined.

As various changes could be made in the above methods without departing from the scope of the invention, it is intended that all matter contained in the above description and shown in the accompanying drawing[s] shall be interpreted as illustrative and not in a limiting sense.

For purposes of illustration, programs and other executable program components, such as the computer executable instructions, are illustrated herein as discrete blocks. It is recognized, however, that such programs and components reside at various times in different storage components of the computer, and are executed by the data processor(s) of the computer.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of data and/or computer-executable instructions, such as program modules, stored one or more tangible computer storage media and executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, computers and/or servers may execute the computer-executable instructions such as those illustrated herein to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules on a tangible computer readable storage medium. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

1. A computer-implemented method for predicting a response of a test virus to antiviral therapy, the method comprising:
a) identifying covariance pairs of amino acid residues independently in a reference responder alignment and a reference non-responder alignment, wherein the reference responder alignment comprises aligned amino acid sequences of viral isolates responsive to the antiviral therapy, and the reference non-responder alignment comprises aligned amino acid sequences of viral isolates that are not responsive to the antiviral therapy, and wherein the test virus and viral isolates are from the same genus;
b) establishing a reference responder network and a reference non-responder network based on the covariance pairs identified independently in the reference responder alignment and the reference non-responder alignment;
c) aligning an amino acid sequence of the test virus independently to the amino acid sequences of the reference responder alignment and to the amino acid sequences of the reference non-responder alignment, thereby generating a test virus responder alignment and a test virus non-responder alignment;
d) identifying covariance pairs of amino acid residues independently in the test virus responder alignment and the test virus non-responder alignment;
e) establishing a test virus responder network and a test virus non-responder network independently based on the covariance pairs identified in the test virus responder alignment and the test virus non-responder alignment; and
f) predicting the response of the test virus as responding to the antiviral therapy if the difference in OMES score between the test virus responder network and the reference responder network is greater than the difference in OMES score between the test virus non-responder network and the reference non-responder network as would be expected by random chance, and if the difference in a number of hydrophobic pairs between the test virus responder network and the reference responder network is greater than the difference in a number of hydrophobic pairs between the test virus non-responder network and the reference non-responder network as would be expected by random chance, or as not responding to the antiviral therapy if the difference in OMES score between the test virus non-responder network and the reference non-responder network is greater than the difference in OMES score between the test virus responder network and the reference responder network as would be expected by random chance, and if the difference in a number of hydrophobic pairs between the test virus non-responder network and the reference non-responder network is greater than the difference in a number of hydrophobic pairs between the test virus responder network and the reference responder network as would be expected by random chance, wherein the method steps (a)-(f) are implemented by one or more computing devices.

2. The method of claim 1, wherein the method further comprises a step of determining independently a number of hydrophobic-hydrophobic interactions between the covariant pairs in the reference responder network and non-responder network.

3. The method of claim 1, wherein the method further comprises a step of determining a number of hydrophobic-hydrophobic interactions between the covariant pairs independently in the test virus responder network and the test virus non-responder network.

4. The method of claim 1, wherein the test virus is a Hepatitis C virus.

5. The method of claim 1, wherein the reference responder alignment comprises aligned amino acid sequences of at least 5 viral isolates responsive to the antiviral therapy.

6. The method of claim 5, wherein the reference responder alignment comprises aligned amino acid sequences of from about 10 to about 25 viral isolates responsive to the antiviral therapy.

7. The method of claim 6, wherein the reference responder alignment comprises aligned amino acid sequences of 15 viral isolates susceptible to the antiviral therapy.

8. The method of claim 1, wherein the reference non-responder alignment comprises aligned amino acid sequences of at least 5 viral isolates that are not responsive to the antiviral therapy.

9. The method of claim 7, wherein the reference non-responder alignment comprises aligned amino acid sequences of from about 10 to about 25 viral isolates that are not responsive to the antiviral therapy.

10. The method of claim 9, wherein the reference non-responder alignment comprises aligned amino acid sequences of 15 viral isolates that are not responsive to the antiviral therapy.

11. The method of claim 1, wherein the antiviral therapy comprises interferon alpha and ribavirin.

12. The method of claim 1, wherein the test virus is isolated from a patient.

13. The method of claim 10, wherein the patient is a human.

14. The method of claim 1, wherein the reference responder alignment comprises aligned full length amino acid sequences of viral isolates responsive to the antiviral therapy.

15. The method of claim 1, wherein the reference responder alignment comprises aligned partial length amino acid sequences of viral isolates responsive to the antiviral therapy.

16. The method of claim 1, wherein the reference non-responder alignment comprises aligned full length amino acid sequences of viral isolates that are not responsive to the antiviral therapy.

17. The method of claim 1, wherein the reference non-responsive alignment comprises aligned partial length amino acid sequences of viral isolates that are not responsive to the antiviral therapy.

18. One or more computer-readable tangible storage media having computer-executable instructions, the instructions comprising:
a) identifying covariance pairs of amino acid residues independently in a reference responder alignment and a reference non-responder alignment, wherein the reference responder alignment comprises aligned amino acid sequences of viral isolates responsive to the antiviral therapy, and the reference non-responder alignment comprises aligned amino acid sequences of viral isolates that are not responsive to the antiviral therapy, and wherein the test virus and viral isolates are from the same genus;
b) establishing a reference responder network and a reference non-responder network based on the covariance pairs identified independently in the reference responder alignment and the reference non-responder alignment;
c) optionally determining independently a number of hydrophobic-hydrophobic interactions between the covariant pairs in the reference responder network and non-responder network;
d) aligning an amino acid sequence of the test virus independently to the amino acid sequences of the reference responder alignment and to the amino acid sequences of the reference non-responder alignment, thereby generating a test virus responder alignment and a test virus non-responder alignment;
e) identifying covariance pairs of amino acid residues independently in the test virus responder alignment and the test virus non-responder alignment;
f) establishing a test virus responder network and a test virus non-responder network independently based on the covariance pairs identified in the test virus responder alignment and the test virus non-responder alignment;
g) optionally determining a number of hydrophobic-hydrophobic interactions between the covariant pairs independently in the test virus responder network and the test virus non-responder network; and
h) predicting the response of the test virus as responding to the antiviral therapy if the difference in OMES score between the test virus responder network and the reference responder network is greater than the difference in OMES score between the test virus non-responder network and the reference non-responder network as would be expected by random chance, and if the difference in a number of hydrophobic pairs between the test virus responder network and the reference responder network is greater than the difference in a number of hydrophobic pairs between the test virus non-responder network and the reference non-responder network as would be expected by random chance, or as not responding to the antiviral therapy if the difference in OMES score between the test virus non-responder network and the reference non-responder network is greater than the difference in OMES score between the test virus responder network and the reference responder network as would be expected by random chance, and if the difference in a number of hydrophobic pairs between the test virus non-responder network and the reference non-responder network is greater than the difference in a number of hydrophobic pairs between the test virus responder network and the reference responder network as would be expected by random chance.

19. A system comprising a processor and one or more computer-readable tangible storage media having computer-executable instructions executable by the processor, the instructions comprising:
an establishing module including computer-executable instructions executable by the processor for:
a) identifying covariance pairs of amino acid residues independently in a reference responder alignment and a reference non-responder alignment, wherein the reference responder alignment comprises aligned amino acid sequences of viral isolates responsive to the antiviral therapy, and the reference non-responder alignment comprises aligned amino acid sequences of viral isolates that are not responsive to the antiviral therapy, and wherein the test virus and viral isolates are from the same genus;
b) establishing a reference responder network and a reference non-responder network based on the covariance pairs identified independently in the reference responder alignment and the reference non-responder alignment;
c) optionally determining independently a number of hydrophobic-hydrophobic interactions between the covariant pairs in the reference responder network and non-responder network;
d) aligning an amino acid sequence of the test virus independently to the amino acid sequences of the reference responder alignment and to the amino acid sequences of the reference non-responder alignment, thereby generating a test virus responder alignment and a test virus non-responder alignment;
e) identifying covariance pairs of amino acid residues independently in the test virus responder alignment and the test virus non-responder alignment;
f) establishing a test virus responder network and a test virus non-responder network independently based on the covariance pairs identified in the test virus responder alignment and the test virus non-responder alignment; a determining module including computer-executable instructions executable by the processor for:
g) optionally determining a number of hydrophobic-hydrophobic interactions between the covariant pairs independently in the test virus responder network and the test virus non-responder network; and
a predicting module including computer-executable instructions executable by the processor for:
h) predicting the response of the test virus as responding to the antiviral therapy if the difference in OMES score between the test virus responder network and the reference responder network is greater than the difference in OMES score between the test virus non-responder network and the reference non-responder network as would be expected by random chance, and if the difference in a number of hydrophobic pairs between the test virus responder network and the reference responder network is greater than the difference in a number of hydrophobic pairs between the test virus non-responder network and the reference non-responder network as would be expected by random chance, or as not responding to the antiviral therapy if the difference in OMES score between the test virus non-responder network and the reference non-responder network is greater than the difference in OMES score between the test virus responder network and the reference responder network as would be expected by random chance, and if the difference in a number of hydrophobic pairs between the test virus non-responder network and the reference non-responder network is greater than the difference in a number of hydrophobic pairs between the test virus responder network and the reference responder network as would be expected by random chance.

20. The method of claim 1, wherein the OMES scores for the test virus responder network and the reference responder network are greater than a lower threshold and less than an upper threshold for OMES responder scores, and the OMES scores for the test virus non-responder network and the reference non-responder network are greater than a lower threshold and less than an upper threshold for OMES non-responder scores.
